(19) United States
(12) Patent Application Publication
(10) Pub. No.: US 2024/0034693 A1
(43) Pub. Date: Feb. 1, 2024

(54) FERTILIZER

(71) Applicant: Incitec Pivot Limited, Southbank Victoria (AU)

(72) Inventors: Charles Norman Walker, Southbank Victoria (AU); Nicholas Hogan, Southbank Victoria (AU); Ellen Durack, Southbank Victoria (AU); Roya Khalil, Southbank Victoria (AU); Timothy Hughes, Southbank Victoria (AU)

(21) Appl. No.: 18/257,556

(22) PCT Filed: Dec. 23, 2021
(86) PCT No.: PCT/AU2021/051554

§ 371 Date: Jun. 14, 2023

(30) Foreign Application Priority Data
Dec. 24, 2020 (AU) 2020904839

(51) Int. Cl. C05D 9/00; C05G 5/12

(52) U.S. Cl. CPC C05D 9/00; C05G 5/12

(57) ABSTRACT

A solid compounded fertilizer in the form of discrete particles, the solid fertiliser having a biological release profile, the solid fertilizer comprising, in a single particle a torrefied organic waste comprising labile carbon and a binder. The torrefied organic material is bound by the binder into the single particle thereby the labile carbon of the organic material is readily available for metabolism by microbes following application of the compounded fertilizer composition to soil or growing media.

The present document claims priority from AU2020904839 the contents of which are hereby incorporated by reference in their entirety.

### TECHNICAL FIELD

The present invention relates to an improved fertiliser. In an embodiment, the improved fertiliser can reduce GHG emissions measured over the lifecycle of the fertiliser when compared with prior art fertiliser repurposed wastes. The invention is therefore also directed to a process for reducing GHG emissions by making use of an improved approach for forming and applying a fertiliser.

### BACKGROUND

Fertilisers can comprise organic material such as plant and/or animal-based materials. The materials can be, for example, manure, carcasses, food waste, organic industrial waste and green litter. Organic and/or carbon-based fertilisers tend to be beneficial to the soil including improving the structure of the soil, stimulating microbial activity and/or gradual release of all essential nutrients to the soil.

Inorganic fertilisers contain minerals and sometimes synthetic chemicals such as those derived from natural and/or synthetic hydrocarbons and atmospheric nitrogen. Inorganic fertilisers can include the main nutrients that plants need to grow and survive such as nitrogen N, phosphorus P, and potassium K. Synthetic fertilisers can include urea, monoammonium phosphate (MAP), diammonium phosphate (DAP), Sulphate of Ammonia (SOA), Muriate of Potash (MOP) and Potassium sulphate (SOP). Nutrients from inorganic fertilisers can leach in the soil and may affect microbial colonies in the application zone. For this and other reasons, inorganic fertilisers are best used together with organic fertilisers at least to maintain soil health.

The contribution of organic and inorganic fertilisers to Green House Gas (GHG) emissions is well documented. Fertilisers can contribute to GHG emissions in several ways across their lifecycle including:
Emissions resulting from storage of green/organic waste prior to use.
Emission from composting processes.
Emissions resulting from energy intensive production processes to make the fertilisers.
Emissions generated during transport of the fertiliser from the production factory to the farm.
Emissions generated during application e.g. by the farm machinery used to deliver it.
Emissions from soil after application.

A lifecycle assessment (LCA) can be undertaken to determine the amount of GHG emitted by a fertiliser which is typically reported as CO2 equivalents.

Due to the inherent differences in consistency, suitable application equipment, safety-requirements and soil activity, organic and inorganic fertilisers are typically applied to soils in two separate application processes. Organic fertilisers tend to be bulky with a consistency like mulch. Inorganic fertilisers come in different forms such as dry powders or pellets (granules, prills, pastelles) or liquids including soluble solutions.

The requirement to attend to two different fertiliser types with two different delivery needs inevitably increases the overall GHG emissions.

The bulky, inconsistent nature and low nutrient concentration of typical organic fertilisers like manure and composts coupled with the difficulty of applying them at low application rates has led farmers to apply them infrequently at high application rates which results in greater potential for GHG emissions where nutrients are often applied at greater rates than needed for a single crop and where often much of the material remains at or close to the soil surface subject to a range of loss mechanisms.

Sometimes, different machinery is required to apply each of the organic and inorganic fertiliser types. The timing of applications may also need to be different for each of the fertiliser types. The nutrients in an organic fertiliser tend to be released slowly over time, which can mean that the amount and number of times that the organic fertiliser is required to be applied to soil can vary over a given time period. Inorganic nutrients are typically immediately available to the plant. Over fertilisation with inorganic fertilisers or incorrect placement or application technique can increase the risk that the concentration of nutrients will damage the plant, especially germinating or immature plants. The requirement to attend to two different fertiliser types with two different nutrient release profiles inevitably increases the overall GHG emissions. The increased GHG emissions are associated with at least transport and application.

It is desirable to reduce GHG emissions during any one of the stages of the fertiliser lifecycle so as to minimise the impact of the fertiliser on the environment. Thus, there is a need for an improved fertiliser formulation which overcomes or at least ameliorates some of the disadvantages of fertilisers of the prior art.

It is to be understood that, if any prior art is referred to herein, such reference does not constitute an admission that the publication forms a part of the common general knowledge in the art, in Australia or any other country.

### SUMMARY OF THE INVENTION

In a first aspect there is provided solid compounded fertilizer in the form of discrete particles, the solid fertiliser having a biological release profile, the solid fertilizer comprising, in a single particle:
a torrefied organic waste comprising labile carbon;
a binder;
wherein the torrefied organic material is bound by the binder into the single particle thereby the labile carbon of the organic material is readily available for metabolism by microbes following application of the compounded fertilizer composition to soil or growing media.

By compounded it is meant that multiple components are combined into one single particle. Compounding is often regarded as the process of combining, mixing, or altering ingredients/starting materials to create a product tailored to the needs of an individual situation.

The organic material or waste can be a natural material. As organic waste such as manure, carcass and/or compost is degraded by microbial processes, there is the inevitable release of GHG gas by the associated microbes. The present process may side-step this release of GHG gas by torrefying the organic waste as soon as possible after its generation. The chemical elements in the waste that would have otherwise been turned to gases and released to atmosphere are instead either trapped in solid form, or captured during the torrefaction process for further use/recycle. This inevitably reduces the GHG emissions calculated for the fertiliser when compared to prior art fertilisers that do not make use of torrefaction. Thus, in embodiments, the methods and products of the present invention can reduce GHG emissions by reducing the amount of microbial degradation of the organic waste. Furthermore, organic wastes often have a high moisture content which further adds to freight, whereas torrefaction removes most of the moisture which avoids or at least reduces the need to transport excess water in such materials. Furthermore, a GHG reduction may come from better placement of the particles of fertiliser in the soil into the zone where nutrients and carbon can benefit plants, rather than leaving the organic material mulch/manure/wet compost (not a dry solid particle) stranded at or near the soil surface away from plant roots and subject to gaseous loss. The ability to get the same/similar or better production outcome from a substantially lower rate of organic material means there is likely to be a subsequent reduction in GHG emissions. Furthermore, nutrient application rates can, in embodiments, be better matched with plant requirements as compared to the typical, infrequent over-application of organic material in prior fertilisers where there is typically an excess of nutrient beyond plant requirements.

In an embodiment, the solid fertiliser further comprises an inorganic or synthetic material. Where the fertiliser is combined with inorganic material, the nutrients in the fertiliser may include at least one of nitrogen (N), phosphorous (P), Potassium (K) or sulphur (S), or combinations thereof. The nutrients can be NPKS (i.e. all of the 4). The nutrients can be one or more of NPKS. The nutrient can be rock phosphate, Magnesium carbonate and plant available silicon. The nutrient can be synthetically made fertilisers e.g. Synthetic materials can include urea, monoammonium phosphate (MAP), diammonium phosphate (DAP), Sulphate of Ammonia (SOA), Muriate of Potash (MOP) and Potassium sulphate (SOP). While some of these are referred to as synthetic, it should be understood that the process for producing them might be that a naturally occurring salt is recovered by either evaporation of brine or by electrostatic separation. It should be understood that the organic material also contains some nutrients, but a desired and consistent, stable and precise nutrient content can be achieved by the addition of the inorganic fertiliser after the torrefaction of the organic component

In an embodiment, the inorganic or synthetic material is provided in the form of separate particles but is mixed together with the particles of the torrefied organic material. In an alternative embodiment, the torrefied organic material and the inorganic or synthetic material can be bound together into the single particle by the binder. In a further alternative embodiment, the inorganic or synthetic material can be coated on the surface of the torrefied organic material.

In embodiments, the methods and products of the present invention can reduce GHG emissions by reducing the amount of fertiliser that needs to be transported to site. If organic fertiliser and inorganic fertiliser are delivered as separate fertilisers, then two separate distribution channels may be required. Each distribution channel has with it an associated GHG emission in CO2 equivalents. A fertiliser that combines organic and inorganic nutrients into one solid form can be transported and delivered by one truck via one distribution channel. This inevitably reduces the GHG emissions calculated for the fertiliser when compared to prior art fertilisers that do not make use of particles comprising organic/inorganic material.

In embodiments, the methods and products of the present invention can reduce GHG emissions by reducing the application rate of fertiliser that needs to be delivered to the soil. The application rate can include the amount applied by weight and the number of applications required over time. If organic fertiliser and inorganic fertiliser are delivered as two separate fertilisers, then two separate amounts of each fertiliser and timing schedules are likely to be required. Each delivery event has with it an associated GHG emission in CO2 equivalents. A fertiliser that combines organic and inorganic nutrients into one form can be delivered to the field by via one item of farm machinery in a single pass. This inevitably reduces the GHG emissions calculated for the fertiliser when compared to prior art fertilisers that do not make use of particles comprising both organic and inorganic materials.

In embodiments, the methods and products of the present invention can reduce GHG emissions by reducing the amount of fertiliser applied to the soil to achieve a desired crop yield. If organic fertiliser and inorganic fertiliser are delivered as separate fertilisers, then more will typically be required of each fertiliser type when compared to the amount of the present fertiliser required. A reduction in the amount of fertiliser in the field will inevitably reduce the GHG emissions calculated for the fertiliser when compared to prior art fertilisers that do not make use of particles comprising both organic and inorganic materials.

It should be understood that references to the numbers “one” and “two” and so on does not mean that the invention is limited to that number and instead it is intended to be reference to a relative reduction in the number of distribution channels, and/or trucks and/or farm machinery vehicles that are employed.

A greenhouse gas (GHG) is a gas that absorbs and emits radiant energy within the thermal infrared range. The process and products of the present invention can in principle include any GHG within scope. GHG can include for example water vapor (H2O), carbon dioxide (CO2), methane (CH4), nitrous oxide (N2O), and ozone (O3). However, the focus of advantageous embodiments is the reduction of one or more of the gases CO2, CH4 and N2O. Thus, in embodiments the GHG does not include water vapour.

Also described is a method of preparing a dry and solid fertiliser in the form of discrete particles, the method comprising the steps of: sterilising an organic waste material to provide a carbon-labile and substantially sterile product; mixing an inorganic or synthetic material comprising at least one of NPKS with the substantially sterile product to produce a mixed product; binding the mixed product to provide a homogenous mixture of organic and inorganic materials; and forming the homogenous mixture of organic and inorganic materials into discrete particles. In some embodiments, the binding and the mixing steps occur concurrently.

In some embodiments, the organic and inorganic materials in the fertiliser are in the same solid particle. By the same solid particle, it is meant that if the single solid particle is selected for analysis the selected particle upon analysis would be shown to have the organic and inorganic components evenly distributed within it. The even distribution is a result of the mixing of the two components (torrefied organic and inorganic material) which can then be milled together. Essentially, the two materials are tossed around together to form a substantially homogenous mixture and formed into one composite particle. The process of forming the composite particles compacts and binds the two (or more) previously distinct materials into one solid composite particle. The inorganic components and organic components are not otherwise supported by any support matrix. In some prior art fertilisers, an organic support may come in the form of a biochar host. In such arrangements, the host provides a porous structure to which inorganic and organic components are added for subsequent release. This is different to the material of embodiments of the present invention which is host free and instead the organic material and the inorganic material are present in and throughout the same particle which can be bound together with a binder. Upon analysis, a cross section of a granule may show a homogenous matrix of organic and inorganic material in a composite particle. The particle of an embodiment of the present invention is shown in contrast to material supported in a porous host as an Example in FIG. 20.

By biological release profile it is meant that any carbon in the fertiliser is available for rapid assimilation by the microbes in the soil. The microbes take up the carbon within days of the fertiliser being applied to the soil. The microbes cease to thrive once the carbon material of the fertiliser is used up as a food source. The inorganic nutrients in some embodiments are slow release with at most about 15, 25, 30, 45 or 50% of the N and/or P becoming available in about the first 1, 2, or 3 months and the remainder being available over subsequent 1 to 3, to 12 to 18 months. In an embodiment over 1 to 12 months. In an embodiment, 50% of the N and/or P is available over the first month and remainder becomes available over the next 1-4 months. Without wishing to be bound by theory, it is thought that most of the available inorganic nutrients are initially used by the microbes in the soil, and these nutrients are released upon death and decay of the native microbial population.

In embodiments in which the organic and inorganic material is in the same solid particle, it is preferable that the material is approximately the size and shape that allows the material to have the same or similar flow properties to other fertilisers delivered by farm machinery. As a result, the fertiliser material according to an embodiment can be substituted into any application equipment adapted for the delivery of prior dry fertiliser. In an embodiment, the fertiliser is spherical in shape and has an average particle size of about 2 to about 3, 4 or 5 mm in diameter.

In some embodiments, the organic and inorganic materials in the fertiliser are not in the same solid particle. In some embodiments, the organic material in the fertiliser is formed into a first solid particle. The inorganic material is formed in to a second solid particle. The first solid particle is different to the second solid particle. The first and second solid particles can be mixed together into the same container, bag, tank, vessel. In embodiments in which the organic and inorganic material are in different solid particles, it is preferable that the materials are each approximately spherical in shape and about 2 to 3, 4 or 5 mm in size. This size and shape may allow the materials to have similar flow properties to other fertilisers delivered by farm machinery. As a result, the fertiliser material of two components can be substituted into any section of a truck adapted for the delivery of prior dry fertiliser.

In some embodiments, the mixture of the inorganic and organic materials is referred to a “homogenous mixture of organic and inorganic materials”. By this it is meant that the fertiliser comprises the two materials distributed substantially uniformly throughout the mixture or particle, which can be substantially bound together. The materials do not have to be chemically bound together but they are at least physically bound together. The fertiliser of this embodiment is not intended to include those with an organic fertiliser applied in one stage, and an inorganic fertiliser applied in a second stage. This would be a heterogeneous mixture of the two and would provide less advantages than some other embodiments of the present invention. An advantage of the dry and solid fertiliser embodiment in which the materials are homogenously distributed throughout an individual particle is that the organic and inorganic fertiliser materials can be applied together in one step using existing application equipment. This represents a significant cost and time saving.

So far, it has been described that the fertiliser can comprise particles of torrefied organic fertiliser bound with a binder, which can be interspersed with particles of inorganic fertiliser of the same or similar size and shape. Furthermore, it has been described that that fertiliser particles can comprise a composite particle of the organic and inorganic materials in a single particle, this being referred to as a homogenous mixture. It is also envisaged that in an embodiment, there is something in between where the organic and inorganic materials are not in separate particles, but also are not uniformly distributed in a single particle. In this embodiment, the organic particles of torrefied waste can be coated with the inorganic macro nutrients at the factory or at the farm just prior to delivery. This outer coating can have the advantage of delivering the macro nutrients in close proximity to the organic nutrients but subsequent to the pelletisation of granulation process. It is important to note here that the host is therefore the organic material in a particle and not some other recalcitrant porous host that plays no role (or an insignificant role) in the dynamic fertilisation process.

The organic waste can be referred to as biosolids. The organic waste is preferably animal waste. The animal waste can be anything derived from an animal that is typically discarded or considered of little value for further processing. The waste can include manure from the animal, carcasses, or other materials used by (e.g. bedding) shed from the animal (e.g. hair, skin, body parts). The waste can include litter. The litter can be a mixture of poultry excreta, spilled feed, body parts e.g. feathers, and plant based material used as bedding in farming operations. The litter can also include unused bedding materials. In some embodiments, the organic waste is green waste. Green waste can include agricultural wastes such as hay (possibly damaged waste hay) or other agricultural biosolids. The organic waste subject to the present method or in the present fertiliser can be mixtures of different types of biosolids. In some embodiments, animal waste comprises at least about 30, 40, 50, 60, 70, 80, 90 or 100 wt. % of the organic component of the fertiliser composition.

In an embodiment, the animal waste is chicken waste. The waste can comprise chicken carcasses and/or chicken manure and/or chicken litter. Chicken waste or poultry litter represents a significant waste stream in some countries. In an embodiment, the animal waste is pig waste. The waste can comprise pig carcasses and/or pig manure and/or pig litter. In an embodiment, the animal waste is cattle waste. The waste can comprise cattle carcasses and/or cattle manure and/or cattle litter. The animal can be any other animal that produces waste. In embodiments, the present invention may provide a method for utilising that waste stream into a recycled and commercially valuable product. The percentages of the various waste of the animal can vary as described herein. Preferably, the waste is not too moist so there may be advantages to using more litter and less manure in the feed stream.

One of the limitations for the direct application of organic waste to soil is the presence of pathogenic microorganisms. For example, animal waste can contain microscopic fungi such as Fusarium, Aspergillus and/or Penicillium spp. Most fusarium fungi are phytotrophs. Aspergillus and penicillium form toxins in soil. A variety of pathogens can be found in chicken litter or chicken litter-based organic fertilizers, such as Actinobacillus, Bordetalla, Campylobacter, Clostridium, Corynebacterium, Escherichia coli, Globicatella, Listeria, Mycobacterium, Salmonella, Staphylococcus, and Streptococcus. Listeria and Salmonella are known to cause fatalities. The fertiliser described herein is a substantially sterile product of organic waste. By substantially sterile, it is meant that pathogens tend not to be present in the fertiliser immediately prior to use. Since it is substantially sterile, the fertiliser is therefore safer to handle than a fertiliser that is not sterile. Listeria infection can lead to unplanned abortions in pregnant women or death of newborn babies. Salmonella, Campylobacter, and Enterohaemorrhagic Escherichia coli are among the most common foodborne pathogens that affect millions of people annually—sometimes with severe and fatal outcomes. It should be understood, that pathogens including bacteria, fungi and yeasts, etc., are present in the air and will inevitably contaminate any material not isolated or otherwise protected. Accordingly, there may be some pathogens present in the fertiliser product, but these would not be in the same number as would otherwise be present absent any sterilisation process.

In order to sterilise the material, chemical, thermal and/or physical methods can be employed. The organic matter of the present fertiliser is preferably subjected to a thermal sterilisation process. It should be understood that other sterilisation processes in addition to thermal sterilisation can be applied. The sterilisation process preferably subjects the organic waste to a temperature sufficient to reduce or eliminate pathogens in the waste. The sterilisation process is to reduce or eliminate the pathogens and may also reduce the moisture content of the organic waste to a point where further microorganism growth is inhibited. This reduction in moisture content may be important for storage and transportation of the organic part of the fertiliser until the point of use when applied to the soil. In embodiments, the sterilisation process can reduce the moisture content to a total water content by weight of at most about 1, 2, 5, 8, 10 or 15 wt. %.

During the thermal sterilisation process, steam and other volatile gases can be flashed off, captured and/or condensed in a gas cleaning system. There is thought to be low nutrient loss from the bulk solid to the condensed vapours. Non-condensable vapours can be sent to atmosphere through a final filtration process. The condensate can be stored on site and optionally recycled back through the process (as a wetting agent) or disposed of. In an embodiment, the condensate is employed in the pelletisation/granulation stage of the process as described further below. The condensate has potential to have other nutrients added (e.g. ammonium polyphosphate (APP) and/or urea) to then be sold as a liquid fertiliser.

In an embodiment, in order to effect sterilisation, the organic material is subjected to a pyrolysis. Preferably, the pyrolysis is a torrefaction of the organic material. Pyrolysis is the thermal decomposition of materials at elevated temperatures in an inert (anaerobic) atmosphere. Pyrolysis of organic materials requires control/elimination of oxygen to avoid partial or complete oxidation (burning). Pyrolysis of organic materials occurs in temperature ranges and typically results in different end products. Pyrolysis begins at about 250 degrees C. and charring at about 400 degrees C. for many natural organics. At the lowest end, composting occurs between 40 degrees C. to 80 degrees C. Torrefaction typically occurs between 150 degrees C. and 350 degrees C. Torrefaction can occur at temperatures of up to 400 to 450 degrees C. In the present process, in embodiments the temperature can be in the range of 100 to 450 degrees C., 250 to 400 degrees C., or 330 to 380 degrees C., with a leaning to the highest temperature permissible without turning the waste in a biochar to minimise torrefier residence time. Biochar is usually produced above ˜750 degrees C. Typically, char becomes more surface active at temperatures above 600 degrees C. Biochars prepared at very high temperatures e.g. >600-700 degrees C. may not be useful at least for agriculture use. Some biochars prepared at around 450-500 degrees C. can provide relatively good results for agricultural use. The present method preferably applies a temperature at which torrefaction occurs, so the organic waste becomes a torrefied product. Residence time in the torrefier can be for about 5 to about 30 minutes to torrefy the waste such as at most 5, 10, 15, 20, 25 or 30 minutes. In particular embodiments, the present method applies a temperature at which torrefaction occurs without the production of biochars. In further embodiments, the present method applies a temperature and time at which torrefaction occurs without the production of biochars.

Torrefaction is thought to be a suitable process technology for the preparation of the present fertiliser, because it can ‘activate’ the organic material at a temperature low enough to prevent evolution of more difficult volatile materials (e.g. tars). Activation is the process of changing the underlying carbon matrix. After torrefaction (˜350 degrees C.), the carbon of the organic waste tends to become more brittle and is relatively easier to grind and compact. The torrefied product has a cellular structure that is similar, but not the same as biochar. Preferably, the present process does not subject the organic waste to temperatures (or temperatures for a sufficient time) that result in biochar. A main difference between torrefied organic waste and biochar, is that torrefied organic waste comprises labile carbon, whereas biochar comprises recalcitrant carbon. It should be understood that there can be a small amount of biochar in the fertiliser without having any deleterious effects, but the main component of the fertiliser is torrefied organic waste having labile carbon that is bioavailable to microbes. In an embodiment there is less than 20%, 15%, 10%, 5%, 1% or 0.5% of biochar. In an embodiment, the ratio of labile carbon to recalcitrant (e.g. biochar carbon) is 85:15; 90:10, 95:5 or 99:1.

Upon application of the dry and solid fertiliser to the soil, the bacteria present in the soil are able to commence metabolising the carbon of the organic material. The organic material is carbon rich. The carbon of the fertiliser particles is predominantly labile. There can be at least about 50 (including 51), 60, 70, 80, 85, 95 or 100% of labile carbon. By labile it is meant that the carbon is bioavailable to micro-organisms in the soil matrix. Another example of a carbon-rich material is biochar; however, as noted above the carbon of biochar tends not to be labile. The carbon in biochar can be referred to as stable or recalcitrant carbon. The present invention is preferably free of stable and/or recalcitrant carbon that is not bioavailable to microorganisms. Biochar is therefore not (as) useful in the fertiliser of the present invention, since the microorganisms are less able to use the carbon. Thus in some embodiments the particles are substantially free of biochar. Biochar may represent firstly a sequestering medium for preventing carbon from re-entering the atmosphere and secondly a slow-release composition for use in planting seeds.

According to another aspect there is provided a method of preparing a solid fertiliser in the form of discrete particles, the method comprising the steps of:
heating an organic waste material to torrefy it at about 150 C to less than about 400 C, optionally about 330 C to less than about 380 C, optionally about 200 C to less than about 350 C, optionally about 250 C to less than about 330 C, to provide a substantially sterile, carbon-labile organic product and at least one by-product,
optionally mixing an inorganic material comprising at least one of N, P, K or S with the organic product to produce a mixed product,
milling the organic material or the mixed product in the presence of a binder to provide a bound material, and
forming discrete particles of the bound material.

In embodiments, the method includes at least one or more of the following energy recovery steps
capturing waste heat generated during the heating step and using it to pre-heat the organic waste material fed to the heating step;
capturing the at least one by-product and recycling it to another step in the process;
transporting the fertiliser via a single distribution channel to a farm.

In another aspect there is provided a method of reducing greenhouse gas emissions while substantially maintaining crop yield, the method comprising: applying or having applied a fertilizer, according to the description of the embodiments of the invention herein, to the field in a single pass using broadcasting equipment, wherein the broadcasting equipment is designed for the controlled dosing of particulate material.

In another aspect, there is provided a process for reducing the amount of GHG emissions measure from a lifecycle assessment of a fertiliser, the process comprising:
preparing or having prepared a solid fertiliser in the form of discrete particles, wherein each particle of the solid fertilizer comprises: a torrefied organic waste; optionally an inorganic material mixed with the torrefied organic waste;
wherein during the step of preparing or having prepared the solid fertiliser, steps are taken to recover energy from the process,
applying the solid fertiliser to soil wherein the organic and inorganic components of the fertiliser are applied in a single-pass using equipment designed for the controlled dosing and placement of pelletized material.

The torrefied structure that results from the present method is preferably helpful for soil health as it may provide a high-surface area porous medium for beneficial microbial growth, water and nutrient storage. The present fertiliser may provide a simultaneous supply of nutrients and compost; nutrients in a form that are sustained release and less likely to cause germination/seedling damage issues but in embodiments, still more rapid and predictable in release than traditional manures and composts.

The method for forming the fertiliser according to some embodiments can comprise the step of mixing inorganic materials e.g. comprising at least one of NPKS with the torrefied organic product to produce a mixed product. This is typically done after the organic component has been subjected to the torrefaction process, however it can be done before in some cases. There is no need to heat treat the inorganic fertiliser ingredients as they will tend to be sterile already due to their high salt and/or ammonium content and the heat/pressure associated with their manufacturing process. Further argument for adding the inorganic material after torrefaction is that certain temperatures may chemically alter the inorganic material fertilisers or melt them in the form provided.

The mixing can be done after each of the organic and inorganic materials have been milled. Alternatively, the mixing can be done before each of the organic and inorganic material have been milled so that they are milled together. In some embodiments, there are advantages to milling the materials together because there may be fewer blockages in the mill and reduced overgrinding of the torrefied base.

In an embodiment in which organic and inorganic is present, in order to mix the two materials, the mixing can be performed by the following process:
The organic ingredients are heat treated (torrefied).
The organic ingredient is mixed with the inorganic fertiliser (and other minerals e.g. reactive rock phosphate and a binding agent). The organic/inorganic mixture is then milled.
The blended organic and inorganic composition can then be subjected to compaction to form discrete particles. This could be any form including granulation, extrusion or pelleting. This process does not necessarily involve external heat but there could be heat due to shear from mixing. In some embodiments, steam or hot water can be used to aid granulation. It is at this step that the recycled condensate could be used.
The granules can be subjected to polishing to achieve spherical shape (free from irregular and sharp edges) and consistent size. Polishing typically requires application of liquid in the form of spray.
The polished granules can then be subjected to thermal drying to ensure the additional moisture is dried off and the granules are biologically inactive for storage and handling purposes. The dried granules will also have better hardness for handling endurance in fertiliser application equipment.

In embodiments in which the organic material is not mixed with inorganic material, the mixing can be performed by the following process:
The organic ingredients are heat treated (torrefied).
The organic ingredient is mixed with a binding agent. The organic mixture is then milled.
The blended organic composition can then be subjected to compaction to form discrete particles. This could be any form including granulation, extrusion or pelleting. This process does not necessarily involve external heat but there could be heat due to shear from mixing. In some embodiments, steam or hot water can be used to aid granulation. For example, at this step that the recycled condensate could be used.
The granules can be subjected to polishing to achieve spherical shape (free from irregular and sharp edges) and consistent size. Polishing typically requires application of liquid in the form of spray.
The polished granules can then be subjected to thermal drying to ensure the additional moisture is dried off and the granules are biologically inactive for storage and handling purposes. The dried granules will also have better hardness for handling endurance in fertiliser application equipment.

Unless the context makes clear otherwise, the following description can be applied to the fertiliser comprising organic material alone or organic/inorganic material. Some moisture is required to form the granules. If there is too little moisture the product will be dusty. If the moisture content is too high, there can be an increased tendency for pathogens to grow in the product. The moisture content can be reduced by selecting a drier blend of organic mixture for torrefaction. The moisture content of the final granules is, in a preferred embodiment, less than 8 wt. % but greater than 1 wt. %. In order to reach this moisture level, the drying period and/or the drying temperature in the thermal drying step can be adjusted. Alternatively, the granules can be subject to more than one drying cycle.

The moisture content of the improved fertiliser granules has an effect on the crush strength (hardness). The crush strength decreases as the moisture content increases. In an embodiment, the crush strength is at least about 2, 2.5, 3 or 3.5 KgF which is comparable to e.g. granules of urea. The particles of improved fertiliser are also similarly sized to urea granules being in the range of from about 2 to about 5 mm in average diameter. In order to reduce any tendency to absorb water, which might affect the resultant crush strength, the particles can be coated. The coating can be a known coating that reduces the hydroscopic nature of the particles.

In the present fertiliser, inorganic nutrients may be added in an attempt to control the amount of nutrients available in the soil. The amount of nutrient added can be determined based on the final intended use of the fertiliser. In some embodiments, the skilled person will perform experiments on the soil to which the fertiliser will be applied. The results of the experiments will reveal which nutrients would be best for the target soil. Alternatively, nutrient requirements may be determined by soil and/or plant tissue analyses.

By using an organic matrix together with inorganic nutrients, a higher load of nitrogen may be able to be loaded into the dry and solid fertiliser. Usually, a large concentration of fertiliser salts and/or ammonium nitrogen in proximity to a germinating seed or immature plant in soil will be detrimental to the plant. However, if there is sufficient organic matter in the surrounding soil environment to bind ammonium nitrogen and other salts this problem may be avoided or at least reduced. The nitrogen then becomes available to the plant later, as the microbes use the carbon as an energy source and ammonium as a protein building block. The amount of ammonium nitrogen in the fertiliser can be at least about 1, 2, 5, 10, 12 or 15% w/w.

The nitrogen N added to the organic material can be in the form of one or more of (but not limited to):
Ammonium Sulphate
Urea
Ammonium Chloride
Ammonium Nitrate
Anhydrous Ammonia
Urea Ammonium Nitrate
Calcium Ammonium Nitrate
Potassium Nitrate
Calcium Nitrate

The percentage of total nitrogen in the fertiliser can be at least about 0, 10, 20 or % w/w. In an embodiment, assuming a minimum of 30% organic material, total N maximum would be limited to around 30% w/w.

In some embodiments, the combination of the inorganic material and organic matter can provide for a potentially explosive combination. In order to reduce the chance that the fertiliser will be combustible, steps can be taken. The steps can include the addition of an explosion retardant. The explosion retardant can be diammonium phosphate (DAP) and/or calcium carbonate.

The phosphorous P added to the organic material can be in the form of one or more of (but not limited to):
Superphosphate
Bone meal
Rock phosphate
Diammonium Phosphate
Monoammonium Phosphate
Triple superphosphate
Phosphoric acid.
Struvite
Ammonium polyphosphate
Mono potassium phosphate

The percentage of total phosphorous in the fertiliser can be at least about 0.5 to about 15% w/w.

The potassium K added to the organic material can be in the form of one or more of (but not limited to):
Potassium Chloride (Muriate of Potash)
Potassium Sulphate
Potassium Schoenite
Potassium Nitrate
Potash derived from Molasses
Mono potassium phosphate

The percentage of total potassium in the fertiliser can be at least about 0.5 to about 12% w/w.

The sulphur S added to the organic material can be in the form of one or more of (but not limited to):
Sulphur powder
Sulphur (granular)
Sulphur bentonite
Ammonium sulphate

The percentage of total sulphur in the fertiliser can be at least about 1 to about 16 w/w.

The formulation can comprise at least one of NPKS or combinations thereof, which means it can contain N and/or P and/or K and/or S. The formulation can comprise all four of the NPKS, or it can contain less than all four of the NPKS nutrients. Not every formulation will contain inorganic forms of each of NPKS e.g. some may only contain N in the inorganic form. Combination additives can also be used including one or more of but not limited to diammonium phosphate, ammonium phosphate sulphate, urea ammonium phosphate, mono ammonium phosphate, ammonium nitrate phosphate, ammonium phosphate, NPK. In addition to the inorganic nutrients listed, the fertilizer can comprise micronutrients including zinc, copper, iron, manganese, boron, molybdenum and secondary nutrients calcium, magnesium and silicon. The percentage of secondary nutrients such as calcium in the fertiliser can be at least about 0.5 to about 18% w/w. The percentage of micronutrients in the fertiliser can be at least about 0.01 to about 2% w/w. The micronutrients could be incorporated into a coating around the outside of the particle. The coating could be applied during manufacture of the particle. The coating could be applied at the farm.

There can be other additives in the composition that do not necessarily provide nutritional benefits, but instead impart other functional improvements. In embodiments, there are additives to increase the mechanical properties of the final product. In embodiments, the formulation includes one or more nitrification inhibitors. Fertiliser nitrogen is inefficiently used in many agricultural soils as plant available nitrate nitrogen is subject to leaching and denitrification losses. One method of reducing such losses is to stabilise nitrogen fertilisers with nitrification inhibitors. This is done by treating the soil (via the fertiliser) with compounds that inhibit the activity of nitrifying bacteria so that nitrogen remains in the more stable ammonium form for an extended period. An example of a nitrification inhibitor is dimethylpyrazole (DMP). This provides a drip feed of nitrate nitrogen offsetting loss events. It is noted that the performance of nitrification inhibitors is variable in Australian soils for a variety of reasons. Plants can also extract ammonium nitrogen from the soil although high concentrations of ammonium and related ammonia can be toxic to plants. It is known that this toxicity can be reduced by the presence of vitamin B6 which is present in animal waste and was detected at trace levels in the finished product. There is also some evidence that zinc oxide can inhibit nitrification while zinc is also an essential micronutrient that is low or deficient in many Australia soils. Accordingly, in some embodiment Zinc is added to the formulation.

Further, field crops are regularly exposed to other abiotic stresses including drought and salinity. Plant available silicon is recognised as an element that can help plants cope with abiotic stresses—in addition, silicon is also a structural building block of plant cell walls. Certain crops like sugar cane and rice have high silicon demand and are often grown on soils or in regions where plant available silicon is depleted. It is thought that an efficient way of supplying nitrogen to plants will be to combine inorganic and organic sources of nitrogen combined with inhibitors that regulate release of nitrogen and with abiotic stress controllers that help plants offset deleterious environmental or chemical factors. Furthermore, there is evidence that some plant species form phytoliths in the presence of silicon which are rigid microscopic structures made of silica which persist after the decay of the plant. These phytoliths also contain resilient carbon and recent research suggests that fertilisation with silicon may lead to carbon sequestration.

In embodiments, the ratio of organic material to inorganic material is 100:0, 90:10, 80:20, 70:30, 60:40, 50:50, 45:55, 40:60, 32.5:67.5 or 30:70. In an embodiment, the base recipe comprises 45% organic and 55% inorganic material (referred to herein as A base, sometimes alongside a number which is an internal reference e.g. A1), or 32.5% organic and 67.5% inorganic material (can be referred to as B base sometimes alongside a number which is an internal reference e.g. B1, B2, B3 and so on); or 100% organic and 0% organic (referred to as C), or 30% organic and 70% inorganic material (can be referred to as E base sometimes alongside a number which is an internal reference e.g. E1).

In an embodiment, the organic material is torrefied with a binder. The binder precursor can be added with the organic material and then delivered to the torrefier. In an embodiment, the organic material is torrefied and then the binder is added post-torrefaction. The binder can be leonardite. The binder can be calcium lignosulphate (CaLigno). Leonardite may be used to condition soils either by applying it directly to the land, or by providing a source of humic acid or potassium humate for application. The carbon geosequestration potential of leonardite, particularly to rapidly accelerate microbial action to lock up and retain carbon in soils, provides the basis for extensive research on the organic fertilising aspect of brown coal.

The leonardite can be present in an amount of at least about 1, 5 or 10% w/w/ of the fertiliser composition. Leonardite is also recognised as a valuable source of humic acid which is a soil conditioner used widely in a variety of farming systems aimed at improving nutrient retention in the soil and also plant uptake of certain nutrients like phosphate. Functional carbon groups supplied by leonardite mixed with other torrefied organic waste may improve plant phosphorus uptake, potentially providing a more efficient phosphorus fertiliser. The phosphorous may be in the fertiliser together with the leonardite (where there is a homogenous blend of organic/inorganic). Alternatively, the phosphorous may be delivered as a separate material during a separate step. Where the phosphorous is delivered separately it will still be in the soil and the leonardite in the fertiliser may still improve plant phosphorous uptake. This is an advantage of using a fertiliser that is not homogenously blended with the inorganic material, and instead comprises the torrefied organic material alone with the leonardite binder. Given that phosphorus is immobile in soils it would necessary that the leonardite be placed very close the P fertilizer e.g. as a blended product in a furrow.

In an embodiment, the activity of the microbial population in the soil can be monitored. Most microbes produce by-products such as carbonaceous products or gases, which can be used as an indicator of soil-microbial activity. If the microbes are very active, then it may be deduced that the nutrient content of the soil is not yet at high thresholds that would damage germinating plants, and so seeds can be planted. If the microbes are less active, this may indicate that the population is in decline and the inorganic nutrients are about to be liberated by the mineralisation process. Where this is the case, and it is not desirable that microbial populations yet decline (e.g. the plant may not be mature enough, seeds may yet need to be planted, or some other reason) it may be advisable to increase the microbial population. It may be possible to increase the microbial population by adding more carbon labile fertiliser to the soil. Accordingly, the soil testing can also be used to determine optimum fertiliser dosing over time and location.

In some embodiments, it might be found that there is no microbial activity in the soil and/or an undesirable microbial ecosystem that is known to be deleterious to some plant or seed types (as would be appreciated by the skilled persons). In such circumstances, the particles of fertiliser could be inoculated with microbes including one or more of bacteria, fungi, yeast or other. This inoculation of the particle could be done as a surface coating. The coating could be applied during manufacture of the particle. The coating could be applied at the farm. The coating could be thought of as a probiotic and/or a prebiotic for the soil ecosystem. The microbes in the coating have the advantage of being delivered with their own food source, so they would essentially metabolise the nutrients in the particle once sowed into the soil. As the microbes use up the food source and perish, the nutrients are given up to the soil. In an embodiment, the microbial inoculants can be added after the granulation/pelletisation step. In an embodiment, the microbial inoculants are added into the process prior to granulation/pelletisation step. Some microbes tolerate very high temperatures.

As discussed, the method includes the step of forming the homogenous mixture of organic and inorganic materials into discrete particles. The dry and solid fertiliser can comprise fines, granules, pellets or prills. The discrete particles in any form can have a size a mean average diameter of at least about 1, 2, 3, 4, 5, 6, 7, 8, 9 or 10 mm. In embodiments, at least about 80, 90, 95 or 100% of the discrete particles fall within 1 standard deviation of the mean particle size (ideally >80, 85 or 90% are in the range of from about 2 to about 5 mm range). It should be understood that each particle of the solid fertiliser comprises the features as defined. However, in any given mixture, the particles of fertiliser might also be present alongside other particles that are not in accordance with the invention. For example, pellets of other fertiliser type including pellets of solely inorganic material.

Granules, like pellets, are small aggregates of a powdered material. Granules tend to disintegrate less quickly than pellets, due to their rounded shape, tend to create less dust and in embodiments allow the binding together of multiple products that are then uniformly distributed through the granule. By uniformly distributed, it is meant that at any one location in a particle of the fertiliser, the relative amounts of inorganic and organic material are about the same as at any other location. Granules are also more aerodynamic when applied through broadcasting machinery and therefore a wider swath can be achieved. In a preferred embodiment, pelletisation is used to prepare the granules.

The fertiliser is described as a dry solid. By dry and solid, it is meant that the material can be handled in the form of pellets (granules). For example, the material can be loaded into a truck and transported and then applied using equipment designed for the controlled dosing of pelletised material. One or more of the components used to form the fertiliser may be liquid.

The method can also include the step of applying the fertiliser. The fertiliser can be applied at rates of at least about 0.05 to about 5 tonnes/hectare. In some embodiments, the fertiliser can increase the yield of crops by 2, 20, 50, or 100%. The ripening of crop can be brought forward by at least 5, 8, or 10% of the time taken without fertiliser. In some embodiments, the fertiliser can be used in the remediation of land comprising soil that is otherwise unsuitable for crops. The carbon-labile nature of the fertiliser can stimulate microbial communities to consume and proliferate, but then die and decay as the food source is depleted. As the bacteria die, the soil can be remediated by release of nutrients in which it was otherwise deficient. Leonardite can be added directly to soils to reduce the take-up of metals by plants in contaminated ground, particularly when combined with compost).

In another aspect of the invention there is provided a method of reducing greenhouse gas emissions while maintaining crop yield, the method comprising:
applying or having applied a fertilizer to the field in a single pass using broadcasting equipment, wherein the broadcasting equipment is designed for the controlled dosing of pelletized material, wherein the fertilizer comprises solid pellets and each pellet comprises a homogeneous mixture of an inorganic or synthetic material comprising at least one of N, P, K, or S nutrients and a torrefied organic material containing labile carbon.

In an embodiment, a different fertilizer is not applied to the field within the same growing season. The growing season is that portion of the year in which local conditions (rainfall, temperature, daylight) permit normal plant growth. While each plant or crop has a specific growing season that depends on its genetic adaptation, growing seasons are generally understood by the persons skilled in the art for their specific crop and/or location.

In an embodiment, the torrefied organic material is applied to the field at a rate that is at least 20% less, at least 30% less, at least 40% less, or at least 50% less than the rate compost would be applied to field, on a dry mass basis, while maintaining comparable yield.

In an embodiment, the greenhouse gas emissions are reduced by at least a comparable percentage to the rate the torrefied organic material is applied to the field as compared to the rate the compost would be applied to field, such as at least a 20% reduction in GHG when the rate the torrefied organic material is applied to the field is reduced by 20% as compared to compost.

In another aspect there is provided a process for reducing the amount of GHG emissions over the life of a fertilizer, the process comprising:
receiving or having received an organic resource, such as an organic waste;
converting the organic resource into a carbon labile, substantially sterile solid fertilizer in the form of discrete particles, while capturing or having captured off-gassable components of the organic resource, wherein the solid fertiliser compatible with delivery by equipment designed for the controlled dosing of pelletized material.

In an embodiment, the organic resource is received within a week, two weeks, a month, two months, three months, or six months of production of the organic resource, thereby limiting off-gassing of the organic resource.

In an embodiment, the captured off-gassable components are incorporated into the solid fertilizer, thereby avoiding or substantially reducing a waste stream.

In an embodiment, the process comprises converting the organic resource into a carbon labile, substantially sterile solid fertilizer in the form of discrete particles, while capturing or having captured off-gassable components of the organic resource comprises torrefying the organic resource.

In an embodiment, waste heat from torrefying the organic resource is used to pre-heat the organic resource prior to torrefaction.

In an embodiment, the process comprises capturing or having captured off-gassable components of the organic resource comprises condensing a torrefier gas produced during torrefying the organic resource.

In an embodiment the process further comprises incorporating an inorganic or synthetic material comprising at least one of N, P, K, or S nutrients into the solid fertilizer, whereby the solid fertilizer includes all the needed nutrients for a particular crop, thereby allowing a single pass of the solid fertilizer to be the only fertilizer needed for the particular crop, thereby further reducing greenhouse gas emissions associated with delivering fertilizer.

### BRIEF DESCRIPTION OF THE FIGURES

Embodiments of the invention will now be described with reference to the accompanying drawings which are not drawn to scale and which are exemplary only and in which:

FIG. 1 is a table showing proposed fertiliser formulations and their organic and inorganic content in terms of percentage.

FIG. 2 is a graph showing the % of absolute signal intensity of different Carbon types in an organic waste material torrefied according to the process described herein.

FIG. 3 is a C13 NMR spectra of an organic waste material torrefied according to the process described herein.

FIG. 4 are C13 NMR of (a) lignite and (b) green waste compost for comparison.

FIG. 5 is a simplified block diagram of a process according to an embodiment.

FIG. 6 is a detailed process flow diagram for an embodiment.

FIG. 7 is Table 1 showing the % breakdown of the organic material (post-torrefaction) including pathogen testing results.

FIG. 8 is Table 4 showing formulation and nutrient content of different torrefied organic bases.

FIG. 9 is a graph of the crush strength of the granules following use of calcium lignosulphanate as a binding agent.

FIG. 10 is Table 5 showing expected and measured nutrient content of sample B1.

FIG. 11 is a graph showing coliform count, crush strength and moisture content.

FIG. 12 is Table 6 showing an example of a torrefied organic base recipe.

FIG. 13 is a table showing the composition of fertilisers according to embodiments of the invention.

FIG. 14 is a table showing GHG emissions from standard farming practice.

FIG. 15 is a schematic showing the standard farming practice.

FIG. 16 is a table showing GHG emissions from a fertiliser according to an embodiment.

FIG. 17 is a schematic showing improved practice.

FIG. 18 is a graph showing GHG emission.

FIG. 19 is a table of application rates and yields.

FIG. 20 is a schematic of an embodiment of a particle of the invention.

FIG. 21 is a graph showing the biological release profile of the fertiliser once applied to soil.

FIG. 22—Response of cumulative CO2 release to addition of different types of fertilizers at 500 (A) and 1000 (B) kg ha-1 in sand and clay soils during 30-day incubation (Preliminary Exp).

FIG. 23—Response of soil CO2 release rates to addition of different types of fertilizers at 500 (A) and 1000 (B) kg ha-1 in sand and clay soil during 30-day incubation (Preliminary Exp).

FIG. 24—Response of cumulative CO2 to addition of different types of fertilizers in sand (A) and clay (B) soil during 28-day incubation. The vertical bars indicate ±standard errors (Main Exp). Note: for the main experiment, all soil had been pre-incubated for 2 weeks.

FIG. 25—Response of soil CO2 release rates to addition of different types of fertilizers in sand (A) and clay (B) soil during 28-day incubation. The vertical bars indicate ±standard errors. (Main Exp). Note: for the main experiment, all soil had been pre-incubated for 2 weeks.

### DETAILED DESCRIPTION OF EMBODIMENTS OF THE INVENTION

The following description focuses on an embodiment in which the organic waste is chicken waste and the sterilisation process is torrefaction. It should be understood that these are used as examples, and other organic wastes could be subject to the process. Furthermore, torrefaction is most preferred, but the skilled person should appreciate that other sterilisation techniques could be performed. Nevertheless, torrefaction does provide a significant advantage in the present process by using low temperature and therefore retaining much of the carbon lability of the organic waste. The carbon labile product optimises soil health and works synergistically with the added nutrients to provide a particularly advantageous fertiliser. The core process described herein in the making of a base material (a torrefied chicken waste) into a powder that can then be mixed with other ingredients to deliver a ‘designed’ nutritional outcome. The torrefied product is optimised for ‘soil conditioning’. The inorganic additives add nutrient intensity and target improved plant productivity.

Raw organic wastes (broiler litter, layer manure, broiler mortalities) from nearby chicken farms can be delivered to the site in bulk. These wastes will vary in nutrient and carbon content based on source farm, available bedding materials, and seasonal changes. The ratio of feeds can vary slightly based on nutrient content and desired product. In time, other organic raw materials may be used as feedstock and stored and handled at the site.

Prior to the torrefaction process, the animal waste can be stored in steel or concrete bunkers. Preferably, the waste is stored in such a way as to reduce any possible biohazard. Animal waste can be particularly hazardous to humans, particular if the subject animal is also human, so stringent health and safety measures should be taken prior to sterilisation. A batch ribbon mixer can be used to mix the poultry waste such as manure, bedding and carcasses (spent chickens). If necessary, the raw organic material can be conditioned in a shredder and/or a hammer mill prior to being conveyed to the torrefier for treatment.

A Front End Loader (FEL) can load the inputs into hoppers at the desired ratios, where they can pass over weighfeeders to then be mixed in a ribbon mixer. The mixed material can be conveyed to a shredder to break the material up prior to feed into the torrefier. Torrefaction heats the material to 250-350 degrees C. and sometimes up to 450 degrees C. in the absence of oxygen. The torrefier does this by heating material passing through a screw conveyor via radiation and conduction from a burner system underneath. This achieves the following outcomes:
Removal of the bulk of the moisture from the material.
Denature any pathogens that may be present in the animal waste feedstock.
Denature residual pesticide/antibiotic molecules that may be present in animal waste feedstock

The process may achieve these outcomes but retains the carbon in a labile (usable) form as the temperature does not reach a pyrolysis point

Steam and other volatile gases can be flashed off, captured and condensed in a gas cleaning system, with low nutrient loss from the bulk solid to the condensed vapours.

The torrefier can be any apparatus fit for purpose. The torrefier can be air sealed. The torrefier can have gas-fired external heating. The torrefier can comprise a screw conveyor. In operation, a torrefying temperature can be decided upon. The temperature selected is based on prior experience with the material to be torrefied. The temperature can be in the range of from about 100 degrees to about 450 degrees C., such as about 250 to about 400 degrees C., or about 330 to about 380. The controller will set how much power to apply to the heating elements to maintain the temperature. A thermostat may be employed to ensure that the temperature remains within a set range. After the temperature reaches the desired level, the wet bio solids (organic waste) can be introduced in a continuous fashion through the inlet port of the torrefier. The organic waste can be picked up by the screw conveyor and transported into the torrefying chamber. The rate at which material passes through the torrefier will depend on the speed of rotation of the conveyor. The heat is applied through conduction through the outer walls and via radiant heating applied to the solids during transport.

In an embodiment, the torrefier can be comprised of more than one screw conveyors in series. The torrefier feedrate can be controlled via feedback loops that regulate the temperature of a main screw outlet, which provides an inferred product moisture content (˜7-10%), based on the feed material. The outlet temperature setting can be adjusted based on moisture analysis and can be limited to minimise pyrolysis of the feed material to an acceptable rate.

All torrefier inputs and the torrefier units themselves can be located in a dedicated building. This may assist in managing the risk of contamination of finished products with pathogens that may be present in raw organic material delivered to the site. There can be three torrefier units in parallel (single feed system, single condensate system).

Once the solids have been torrefied, the treated organic material can be transported out of the torrefier. The material can fall under gravity from the torrefying chamber into a suitable container. The torrefied material can be cooled to at or just above room temperature to aid in further handling. Optionally, the cooling is the post torrefaction cooling via the water jacketed screw conveyor. The container filled with torrefied material can be a bag supported by a bag unloader. At predetermined intervals, the torrefied material can be tested to ensure that it meets the sterilisation requirements and moisture content. If there are any testing problems, the process can be stopped and the parameters in the torrefier can be adjusted.

The torrefier product can be conveyed to the adjacent granulation building for storage in intermediate silos. These silos can be designed to allow retrofit of an infeed system to support a future “hub & spoke” supply of torrefied material from on-farm torrefaction units.

Inorganic fertilisers (eg RPR/SOP blends, Urea, DAP/MOP blends) can be delivered to site in bulk and offloaded via screw conveyor to storage silos. There can be facility for other trace nutrients (eg Zn/Cu/Mo materials) to be delivered in 1 tonne (T) bags and stored for use as needed in the future.

Leonardite can be added in an amount of at least about 2, 5, 10 or 15% of the total product. Leonardite can be delivered to site in bulk or e.g. in 1 tonne (T) bags and stored for use as needed. The leonardite can be added post torrefaction as it is a pathogen free material, and it is added due to its high carbon content and presence of humic acids which is thought to aid granulation and to contribute to soil heath.

To obtain finished product granules that contain a homogenous mixture of torrefied organics, leonardite and inorganic fertiliser, the materials are mixed and ground in a hammer mill to achieve the desired size reduction, then wetted down in a mixer to increase moisture content using either fresh water or recovered condensate or other nutrient rich waters, then sent to the pelletisation or granulation process.

Pelletisation involves transporting the mixture into a pellet extruder and cutting machine, followed by balling mills, optionally three arranged in series. At all appropriate stages, liquids can be sprayed to reduce dust and aide rounding of the pellets into spheres.

Granulation involves transporting the mixture into a rotary drum, whereby recycled material and moisture is also added. The rolling action of the drum results in the fresh material coating and forming to increase the size of the recycled undersize material, increasing overall size distribution of the granulator product compared to the recycle feed.

The feed, mixing and milling processes can be continuous so to deliver a continuous stream of ground feed to the wetting mixer. Some mixtures are more suited to pelletisation that others. The skilled person can try pelletisation and granulation, to see which suits the mixture employed.

The principle of pelletising is to wet all feed to the pelletiser to a set level to achieve sufficient combining of material under pressure with sufficient lubrication to pass through the die. Not enough or too much water can result in plugging/bogging of the roll-heads and die, as well as weak product and excess fines.

For products made using pelletisation, the raw milled feed can enter the wetting mixer with recycled undersize product and water (or torrefier condensate) added to wet the mix down prior to pelletising. The pelletising/balling process is anticipated to yield approximately 70% on-size product, so about 30% of all material fed to the pelletiser is returned back as recycle (a 0.43:1 recycle ratio).

The wetted material can be fed to parallel pelletisers (2×50% duty) to generate small cylinders of product, and then to a series of balling mills to round the sharp edges of the pellets and change their shape to spheres. The balling mills are comprised of a rotating disc which throws the product into a vertical wall around the disc, which imparts a rolling action into the bulk material as it spins around the mill. Water (or torrefier condensate) can be added to aid the softening of the edges and to plasticize the pellets to change shape. Balling will also yield combination of some fines into larger on size particles. The rounded material can then fed to the downstream dryer and screening processes.

Granulation involves transporting the mixture into a large open rotary drum, whereby recycled undersize granules are also fed into. Fresh mixture and recycled granules may optionally be mixed prior to feed to the drum and the combined bulk moisture increased in a mixer. The rolling action of the drum creates intimate contact between recycled/fresh and fresh/fresh particles which results in coating of the recycled material with fresh material, which increases their particle size. In addition, agglomeration of different smaller particles occurs to create new larger granules. Wetting sprays may or may not be used to spray water or other liquids onto the bed of material in the drum to aide in granule growth/formation. The size distribution at the exit would typically yield between 20% to 80% on size granules (depending on product being made). The granulated materials can then be fed to the downstream dryer and screening processes.

A gas burner can be used to heat air which is fed into the dryer drum to dry the granules. The dryer exhaust gases can be captured via a bag house, with an extraction fan venting the cleaned gases to atmosphere. The dry solid fertiliser product can be screened (2 deck vibrating screen). After oversize screening, the product can pass through a fines screen to remove undersize. On spec then passes through a rotary cooler drum and then a polishing screen to remove dust. Undersize from the fines and polishing screens can be recycled back to the pelletiser or granulator. The dry solid fertiliser product optionally in the form of granules can have a moisture content less than about 10, 8 or 5% (preferably less than 5%) moisture for shelf stability and to prevent (or at least reduce) the regrowth of pathogen in the granules.

Post cooling and polishing screen, the product can be conveyed to onsite storage silos or bulk storage shed for despatch into bulk trucks or fed into the on-site bagging line to be stored in e.g. 1T bags. Assuming the product meets all the required standards, it can be sold in bulk or bagged and marked for sale and use.

### EXAMPLES

Embodiments of the invention will now be exemplified with reference to the following non-limiting examples.

### Example 1—How to Determine the Expected Nutrient Content of a Fertiliser

In order to determine the effectiveness of a fertiliser formulation, various formulations can be created in accordance with the present disclosure. The skilled person can then determine which formulation is best for use on which type of soil and for which type of plant intended to be grown in that soil. By way of example, different formulations are proposed and these can be labelled A to M for internal reference.

As an example, fertiliser formulation A can be prepared by the torrefaction of organic material comprising chicken manure litter, layer manure and, spent hens. The organic material can be stored and then conveyed to a torrefier. A temperature of 150 degrees C. to about 350 degrees C. can be employed for about 5 to about 30 minutes to torrefy the waste. Once the solids have been torrefied, the treated organic material can be transported out of the torrefier and cooled before being collected into a container. Batches may be taken from the container and sent to a ribbon mixer where the torrefied material will be mixed before being ground in a mill (e.g. hammer mill) for e.g. up to 20 minutes although shorter times can be employed. Liquid and solid inorganic fertilisers such as Ammonium sulphate and APP may be added to the ground product and mixed. The organic component can be about 20-80%; binder about 5-10%; and the inorganic component about 20-70% of the total weight of the ground material. The mixed organic and inorganic materials can be sent for pelletisation.

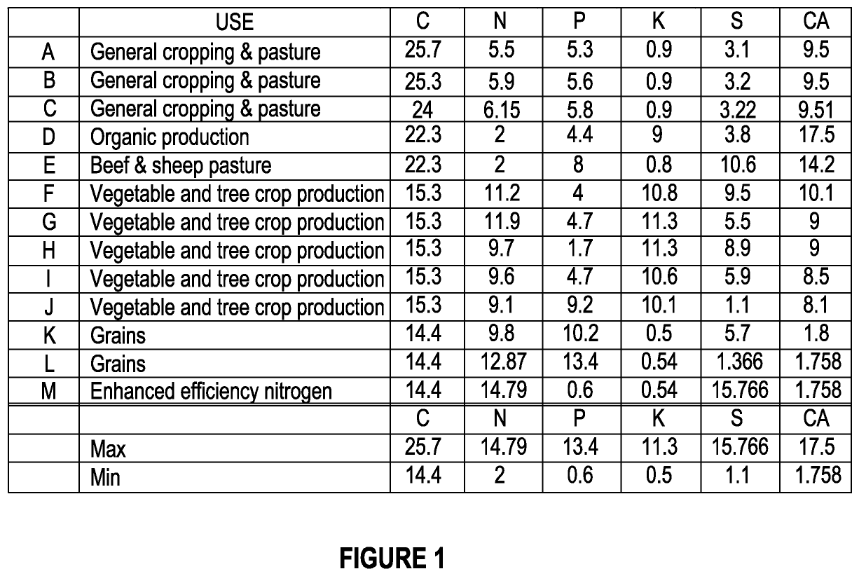

The expected breakdown of carbon (C), nitrogen (N), phosphorous (P), potassium (K), sulphur (S) and calcium (Ca) in the fertiliser is shown in Table 1 of FIG. 1.

Table 1 of FIG. 1 also shows the proposed formulation of compositions B-M that can be prepared in a similar way to that described above.

In addition to the different formulation, the time spent in the torrefier may be varied from 30 minutes to 15 minutes, 1 hour, 2 hours, 3 hours. Furthermore, the effect of temperature will be explored from 150 to up to 350 degrees C. Also, the time spent grinding may be more or less than 20 minutes.

Each of the fertilisers can then be tested on soils to determine their efficacy in promoting plant growth and overall health.

### Example 2—Analysis of the Torrefied Product

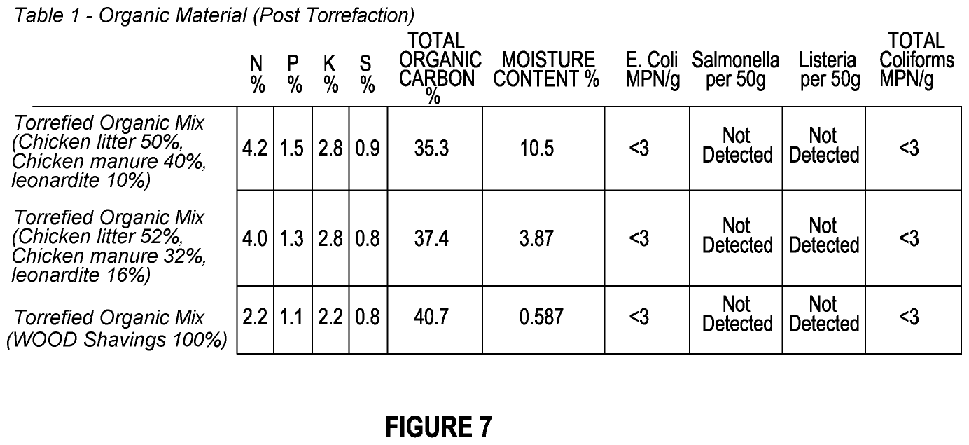

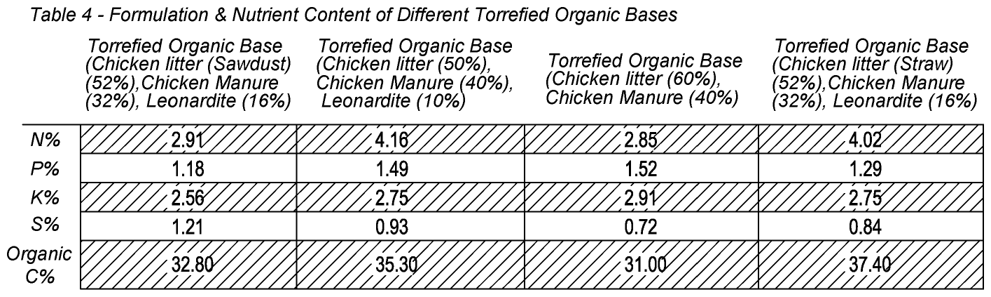

The sterile nature of the torrefied organic component of the formulation is shown in FIG. 7.

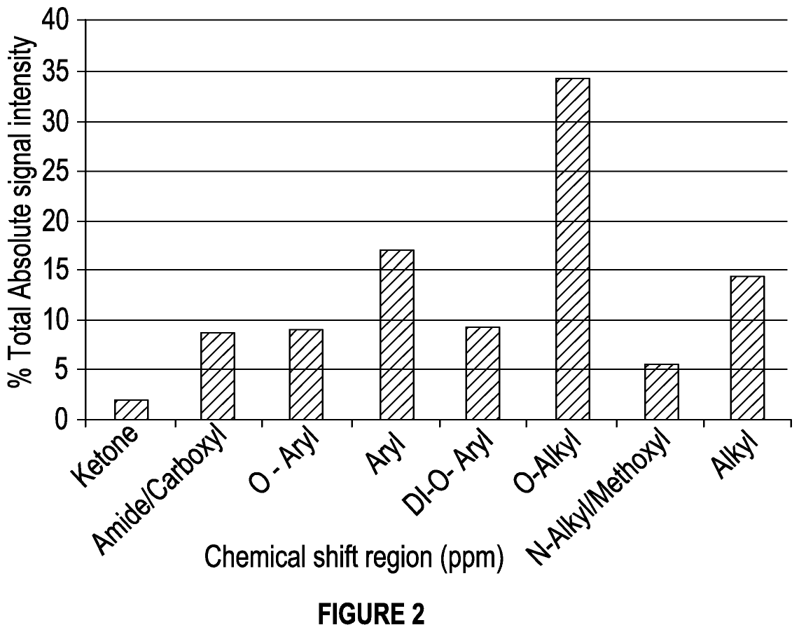

An analysis of the carbon labile nature of the torrefied material was undertaken. The results are shown in FIG. 2. The torrefied material contains a range of carbon forms. The key forms of interest are:
Carboxyl C—This includes carboxylic acids, including short chain organic acids. These contribute to soil processes impacting on nutrient availability. These are easily decomposable by soil microbes.
Aryl C—These include aromatic C compounds incorporating a benzene ring structure, which is a function of more ‘mature’ organic materials. While these compounds also contribute to nutrient availability, they have a longer residence time in soil due to their ring structure being more resistant to microbial degradation. They may contribute to C sequestration.
O-Alkyl C—This class includes all polysaccharide (sugar-type) and carbohydrate compounds. These will stimulate localised microbial activity as they are easily-available microbial substrates. This material may also have a ‘priming’ effect whereby it stimulates mineralisation of other, not so available soil C sources.
Alkyl C—This class includes fatty acids, lipids and other long-chain aliphatic compounds. While these are likely to be consumed by microbes as sources of energy, they don't contribute to nutrient release or C sequestration.

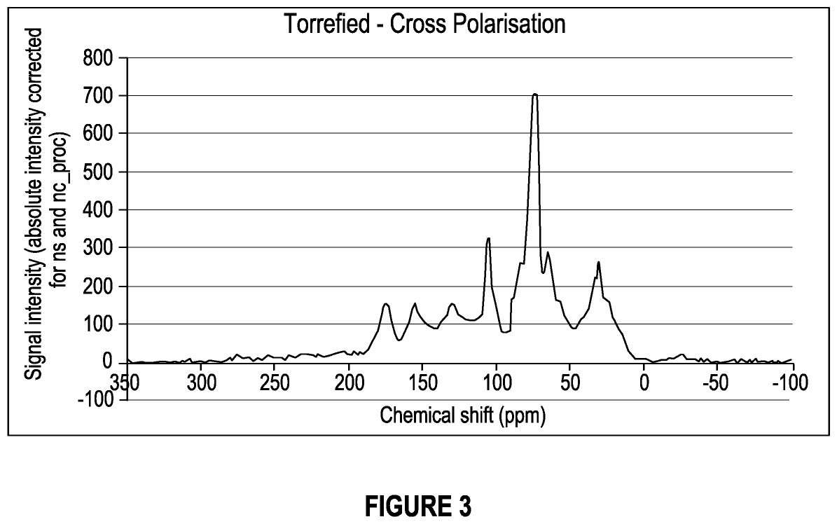

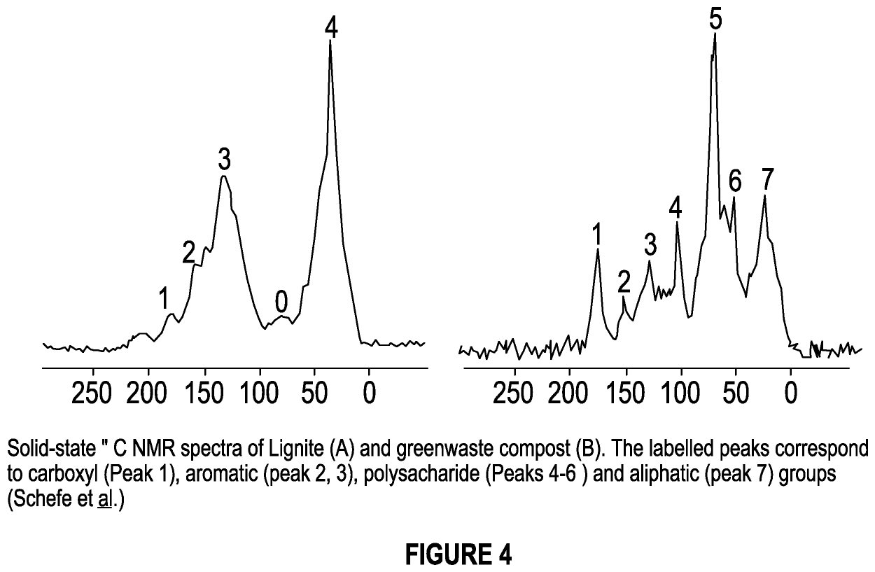

The 13C NMR spectrum is shown in FIG. 3, with the various C classes being measured as groups of peaks at different ‘chemical shifts’. The large peak at about is the polysaccharide/carbohydrate peak. This shape of spectrum is similar to that seen in other compost-type organic amendments. So, the torrefaction retains many of the benefits of other organic processing, such as composting, while concentrating the carbon and removing pathogens. Another NMR example is shown in FIG. 4, compared with lignite and compost.

### Example 3—a Specific Example of Preparation of a Fertiliser According to an Embodiment

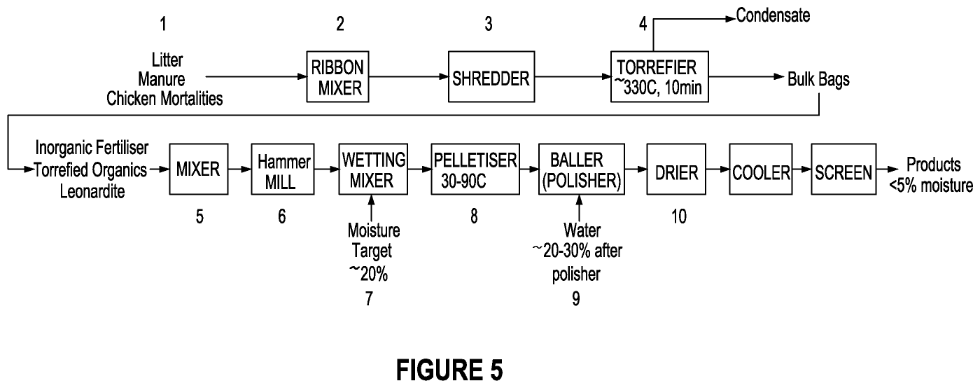

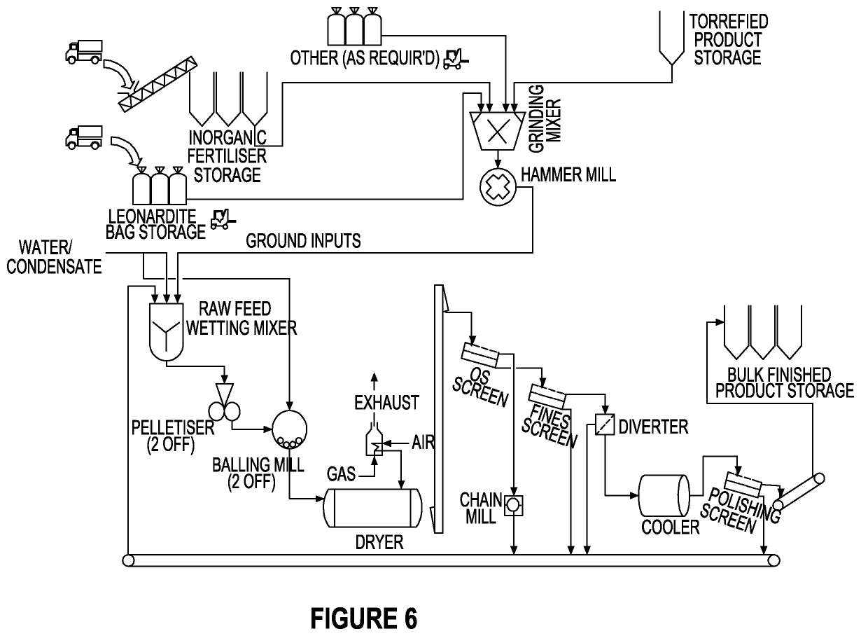

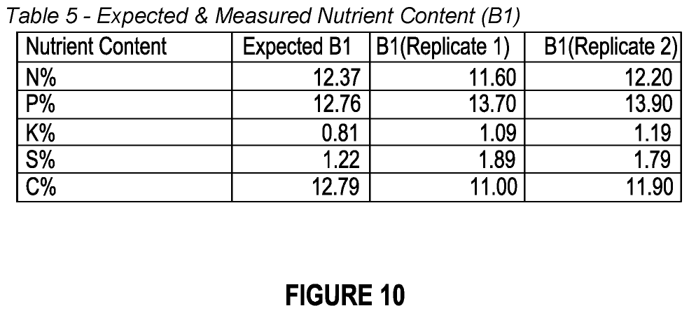

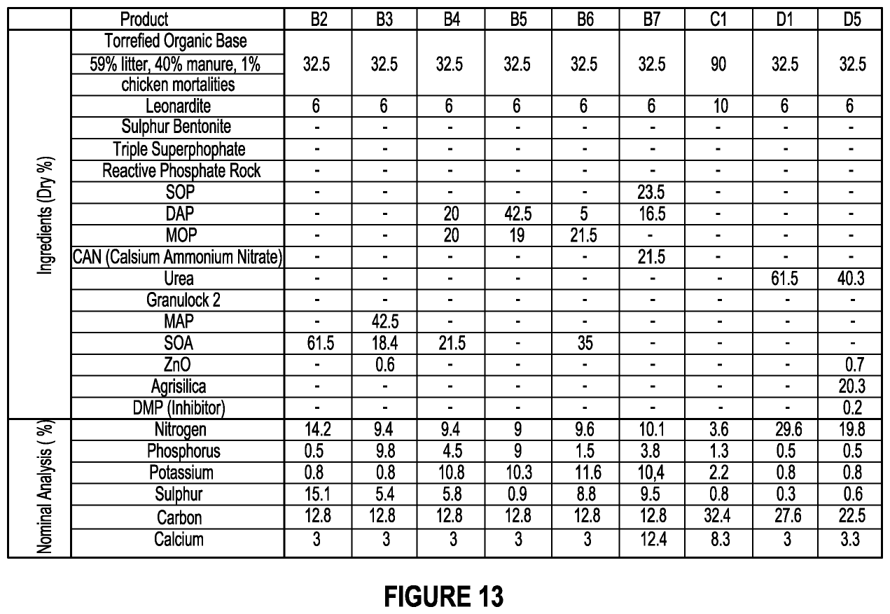

The flow diagrams of FIG. 5 and FIG. 6 present a schematic view of the process from the raw materials to packing of final granules. The steps are outlined below and are labelled in FIG. 5.
1. Organic raw materials (chicken litter, chicken manure, and chicken carcasses were received in separate bays).
2. All the organic raw materials were fed into a ribbon mixer at the specified ratio (e.g. Table of FIG. 13) and well mixed before entering the shredder.
3. The mix was shred into small and consistent particle size before entering the torrefaction process. This step allowed for a uniform torrefaction (heat distribution) due to consistent size.
4. The shredded mix was introduced to a torrefier unit where the mix was exposed to an elevated temperature of 330° C. in the absence of oxygen. The torrefaction process reduced the moisture of the mix significantly (from 40% moisture content to less than 10% moisture content).
5. The torrefied organic material was then introduced into a mixer with inorganic fertiliser granules and binding agent at a specified ratio e.g. the Table of FIG. 13 (as per product formulation recipes).
6. The mixture of organic and inorganic material was then introduced into a hammer mill to grind the particles and further mix the material for homogeneity. An example of the homogeneity of the composition of the final mixed pellets is shown in FIG. 10.
7. The milled and homogenised mix was then introduced to a wetting station where a liquid (water or liquid fertiliser or condensate from the process) was added to the mix to prepare for pelletisation.
8. The wet mix is then introduced into the pelletiser for granulation.
9. The granules from the pelletiser were introduced to a polisher along with a liquid (water or condensate from the process) to further polish the granule surface and produce uniform spherical granules.
10. The polished granules were introduced into a drier to remove the excess moisture content. The moisture was reduced to be in the range of at least about 1% to at most about 9%.
11. The dried granules were then cooled to storage temperature possibly by ambient cooling or a fan.
12. The cooled granules were further screened for lumps and large particle size before dispatch to storage or packing.

### Example 4—Choice of Torrefied Base

The animal waste used for the products was torrefied in various proportions to produce “bases”. Nutrient analysis results for four of these bases are shown in Table 4 of FIG. 8. The moisture content of the bases does vary and is increased according to the presence of manure/carcass (wet) and decreases according to the presence of litter (dry materials). It has been found, however, that other than variations in moisture content, the overall nutrient content of the organic feedstock does not significantly impact the amount of labile carbon in the finished product. This means that the improved fertiliser can tolerate varying percentages of the litter/manure/carcass in the torrefied base provided the resultant carbon content is in the range of from about 30 to about 40% of total.

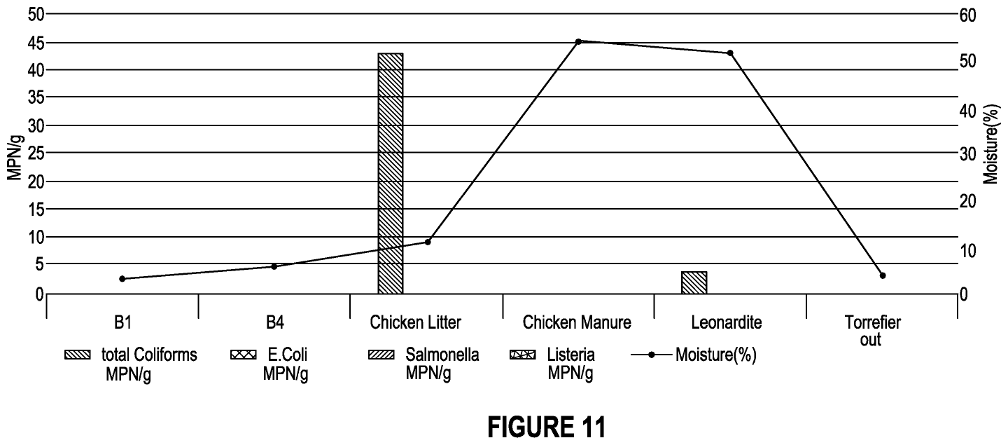

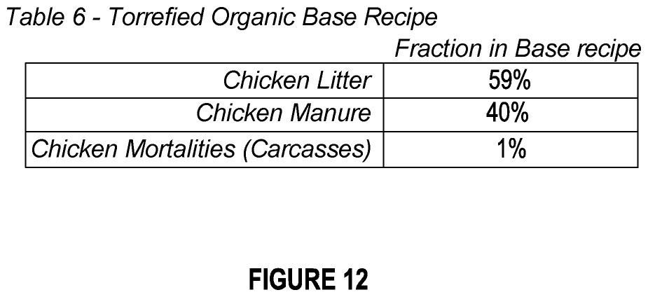

Three batches of organic waste materials were also analysed post torrefaction by an independent laboratory (SWEP) for nutrients, carbon and pathogens. The results are shown in Table 1 of FIG. 7. As can be seen in Table 1, the torrefied product is substantially sterile due to the absence of E. coli, Salmonella and Listeria (total coliforms (<3)). The lack of coliforms can also be seen in the graph of FIG. 11. The fertilisers labelled as B1 and B4 has no coliforms, desired hardness and desired moisture content.

### Example 5—Hardness/Crush Strength

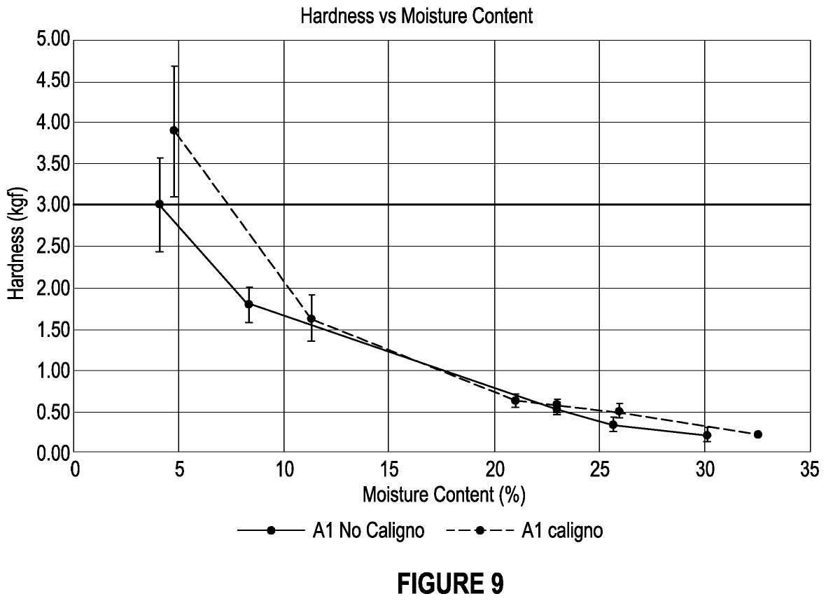

Crush strength which is a measure of granule hardness is used a granule performance indicator. Experiments were conducted using Lignosulphonate as granulation binder to further improve the crush strength (granule hardness). FIG. 9 shows results from one such experiment. It can be seen from the data in FIG. 9 that at a moisture content of less than 10% the hardness of the granules with calcium lignosulphanate is significantly higher than without the binder.

### Example 6—Improved Fertiliser Formulations

A number of formulations were produced using a torrefaction and granulation process to manufacture fertiliser pellets including organic and inorganic materials. The torrefied organic material was then mixed with inorganic fertilisers in varying mixtures and ratios and the mixture was granulated. The compositions are shown in the Table of FIG. 13. The final granules were sent to the laboratory for nutrient, moisture and compositional analysis.

Soil incubation and glasshouse experiments were conducted in sandy soil and clay soil to understand the effect of the fertiliser product(s) in different soil structures and nutrient compositions.

Soil Incubation
Breakdown of organic material was observed in both soil types, however this was more clearly seen in the sandy soil due to the lower nutrient loading, organic matter and microbial activity compared to the clay
Release of cations was observed over the experimental period, which was reflected in the relationship between CEC, C:N ratio and Labile Carbon
Mineralisation of Potassium and Phosphorous was seen, with increased mineralisation occurring with Torrefied Organic products compared to their controls
Torrefied Organic products were observed to have similar Ammonium and Nitrate over the experimental period compared to their controls, which showed no major Nitrogen immobilisation was occurring in both soils
Due to the high organic content and microbial activity, Ammonium N was observed to convert rapidly into Nitrate N
Some Torrefied Organic products were observed to have a slower, more controlled release on N compared to their controls

### Glasshouse

Performance of the product(s) is better than just soil (i.e. nil fertilizer control) for both corn (clay) and lettuce (sandy), providing increased yield and higher nutrient uptake
The agronomic effects are more evident in the sandy soil than clay soil due higher fertility of the clay soil
Different application rates for the product (B4) were trialed, and an optimum range was identified
Two application rates were trialed for all other treatments. Varying responses were observed by product

Field trials were treated with additional composted chicken manure while pot trials were treated with additional raw chicken manure. The manure/compost was added for comparison with the ABF products (e.g. B1, B4, B5, B6, B7, D5 etc) with separate applications of manure or compost followed by an application of conventional NPK fertiliser. The expectation would be that nutrient availability would be similar from either raw manure or composted manure—the composted material simply having less pathogens and in some cases a bit less nitrogen (which was lost during composting).

The % dry matter yield is dry matter (grams per pot) divided by the control (no fertiliser applied).

Hypothesis 1: Torrefied Organic Material Will Perform as Well or Better than Manure/Compost

Finding: True

| | % dry matter yield increase v’s control | | | |
|---|---|---|---|---|
| | Lettuce Pot | Corn Pot | | |
| | trial sandy | trial clay | Field trial | Field trial |
| Treatment | soil | soil | lettuce | broccoli |
| Manure or compost only¹ | 51 | 2 | 6 | 51 |
| C1 (torrefied organics) | 65 | 0 | 9 | 52 |

The C1 torrefied organics does not have inorganic material added. This experiment is intended to demonstrate that the labile carbon in the torrefied organic material is superior to manure or compost when used alone. As can be seen from the results, the % dry matter in field trials is generally increased by the use of the torrefied material adding support for its use in an improved fertiliser composition.

Hypothesis 2: Co-Granulated Torrefied Organics/Inorganic Chemical Fertiliser Compound Will Perform as Well as Manure/Compost+NPK Chemical Fertiliser Blend

Finding: True

| | % dry matter yield increase | |
|---|---|---|
| | v’s control | |
| | Field trial | Field trial |
| Treatment | lettuce | broccoli |
| NPK blend | 23 | 119 |
| NPK blend + compost/ | 24 | 107 |
| manure | | |
| B4 (torrefied organics | 13 | 104 |
| compounded with NPK) | | |
| B5 (torrefied organics | 18 | 120 |
| compounded with NPK) | | |
| B6 (torrefied organics | 35 | 115 |
| compounded with NPK) | | |

B4, B5 and B6 compositions according to embodiments of the invention each have 32.5% torrefied organic base and 67.5% inorganic material. The suffix 4, 5 and 6 are used to denote that each of the B formulations has a slightly different inorganic formulation. The exact nutrient % of the formulations are shown in the Table of FIG. 13.

When considering the performance overall, it should be borne in mind that in NPK blend+compost/manure, the formulations have to be delivered in two separate steps which is a disadvantage as described in the background section above. The improvements seen for field trial lettuce and field trial broccoli are therefore considerable improvements since the fertiliser according to an embodiment of the present invention B4, B5 and B6 was added in one step.

Hypothesis 3: Co-Granulated Torrefied Organics/Chemical Fertiliser Compound Will Perform as Well or Better than Manure/Compost+NPK Chemical Fertiliser Compound

Finding: True

| | % dry matter yield increase v’s control | | | |
|---|---|---|---|---|
| | Lettuce Pot | Corn Pot | | |
| | trial sandy | trial clay | Field trial | Field trial |
| Treatment | soil | soil | lettuce | broccoli |
| Nitrophoska | 87 | −1 | 27 | 111 |
| Nitrophoska + compost/ | | | 26 | 107 |
| manure | | | | |
| B7 (torrefied organics | 71 | −4 | 31 | 136 |
| compounded with | | | | |
| NO₃PK) | | | | |

NO₃PK is sometimes referred to by the trademark Nitrophoska. The improved results with B7 when compared to Nitrophoska used alone or in combination with compost/manure should be clear from the results shown in the Table. The % dry matter yield for lettuce increased from 26% to 31% when using the improved fertiliser B7 according to an embodiment of the invention. The % dry matter yield for corn increased from 107% to 136% when using the improved fertiliser B7 according to an embodiment of the invention.

Hypothesis 4: Co-Granulated Torrefied Organics/SOA Compound Will Perform as Well or Better than SOA

Finding: True

| | % dry matter yield increase v’s control | | | |
|---|---|---|---|---|
| | Lettuce Pot | Corn Pot | | |
| | trial sandy | trial clay | Field trial | Field trial |
| Treatment | soil | soil | lettuce | broccoli |
| Sulphate of Ammonia | 66 | 36 | | |
| (SOA) | | | | |
| B2 (torrefied organics | 138 | 66 | | |
| compounded with SOA) | | | | |

The improved results with B2 when compared to SOA used alone should be clear from the results shown in the above Table. The % dry matter yield for lettuce increased from 66% to 138% when using the improved fertiliser B2 according to an embodiment of the invention. The % dry matter yield for corn increased from 36% to 66% when using the improved fertiliser B2 according to an embodiment of the invention.

Hypothesis 5: Co-Granulated Torrefied Organics/MAP-S-Zn Compound Will Perform as Well or Better than Granulock Z

Finding: True

| | % dry matter yield increase v’s control | | | |
|---|---|---|---|---|
| | Lettuce Pot | Corn Pot | | |
| | trial sandy | trial clay | Field trial | Field trial |
| Treatment | soil | soil | lettuce | broccoli |
| Granulock Z | 100 | 32 | | |
| B3 (torrefied organics | 138 | 56 | | |
| compounded with MAP- | | | | |
| S-Zn) | | | | |

MAP-S-Zn is referred to by the trademark Granulock Z which is a registered trademark of Incitec Pivot. The improved results with B3 when compared to MAP-S-Zn used alone should be clear from the results shown in the above Table. The dry matter yield for lettuce increased from 100% to 138% when using the improved fertiliser B3 according to an embodiment of the invention. The % dry matter yield for corn increased from 32% to 56% when using the improved fertiliser B2 according to an embodiment of the invention.

Hypothesis: Co-Granulated Torrefied Organics/Urea Compound Will Provide Significant Yield Increases, More so with Add Si & DMP Inhibitor

Finding: True

| | % dry matter yield increase v’s control | | | |
|---|---|---|---|---|
| | Lettuce Pot | Corn Pot | | |
| | trial sandy | trial clay | Field trial | Field trial |
| Treatment | soil | soil | lettuce | broccoli |
| D1 (torrefied organics | 38 | 77 | | |
| with urea) | | | | |
| D5 (torrefied organics | 77 | 86 | | |
| with urea + silicon + Zn + | | | | |
| DMP) | | | | |

The improved results with D5 having the addition of silicon, Zinc and DMP can be seen when compared to the formulation Dl. The % dry matter yield for lettuce increased from 38% to 77% when using D5 according to an embodiment of the invention. The % dry matter yield for corn increased from 77% to 86% when using the improved fertiliser D5 according to an embodiment of the invention.

### Example 7—GHG Emissions

Greenhouse gases were calculated as:
1 litre diesel=3.28 kg CO2e
1 kg N2O=265 kg CO2e
1 kg CH4=24 kg CO2e

For Fertilizer Theoretically Applied According to Standard Farmer Practice:

Control: Compost is surface applied at a dry matter equivalent of 2 t/ha once a year and NPK fertiliser is applied in a separate application drilled into hill 4 times a year at 500 kg/ha.

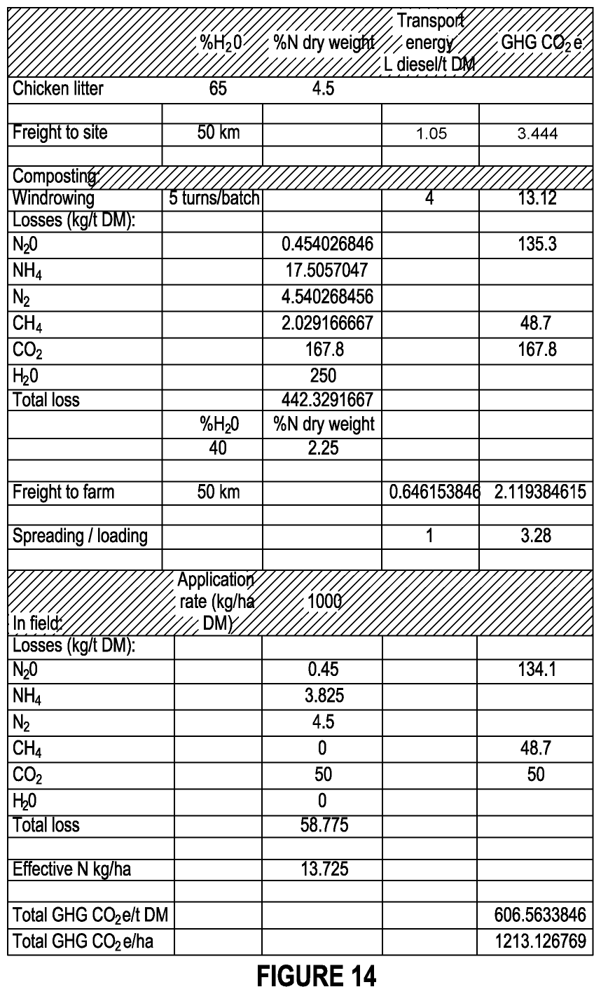

As can be seen from the Table of FIG. 14, for the purposes of assessing the GHG emissions for the LCA of the fertiliser, the off-gassing of the chicken litter during composting is estimated at about 365 kg GHG CO2e/tonne of dry matter (DM).

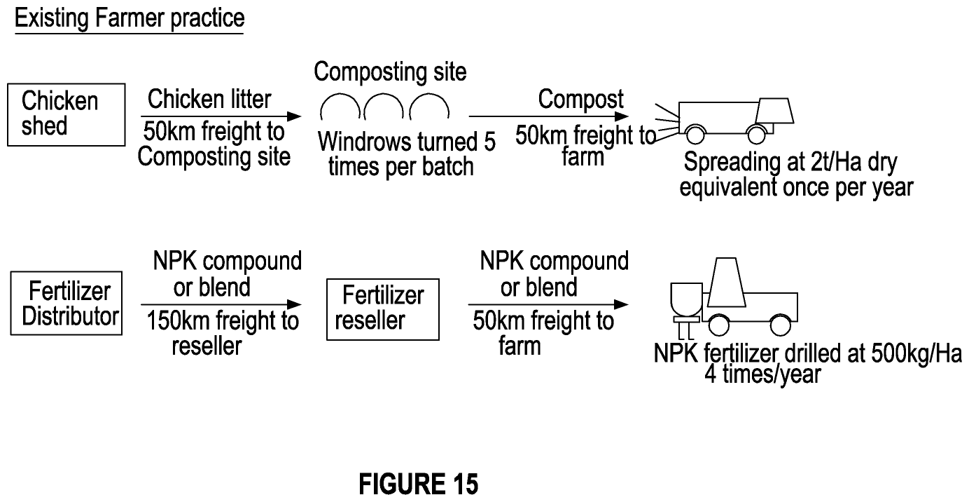

The transport load of the chicken litter is estimated at 50 km for transportation of the organic litter to the composting site, and about 50 km freight to farm (total 100 km). The amount of diesel is estimated at about 5.5 kg GHG CO2e/tDM. This is also shown schematically in FIG. 15. FIG. 15 also shows the inorganic transport which is discussed further below.

The spreading loading of the fertiliser in the field is estimated to generate about 3.3 kg GHG CO2e/tDM.

In the field, the GHG emitted is estimated to be 232 kg GHG CO2e/tDM.

In total, the GHG CO2e/ha is 606.56 per tonne DM of compost. There are 2 tonnes of compost applied per year on a dry matter basis, so to the total GHG CO2e/ha is 1213.12 kg.

The assumptions that the horticultural grower is planting 4 crops per year, and that there is one annual application of compost.

The Solid Fertiliser Theoretically Applied According to an Embodiment of the Present Disclosure

The solid fertiliser contains about ⅓ organic material and is drilled into the hill 4 times a year at 750 kg/ha providing 250 kg of organic material each time. The total organic material supplied is 1000 kg/ha over the course of a year.

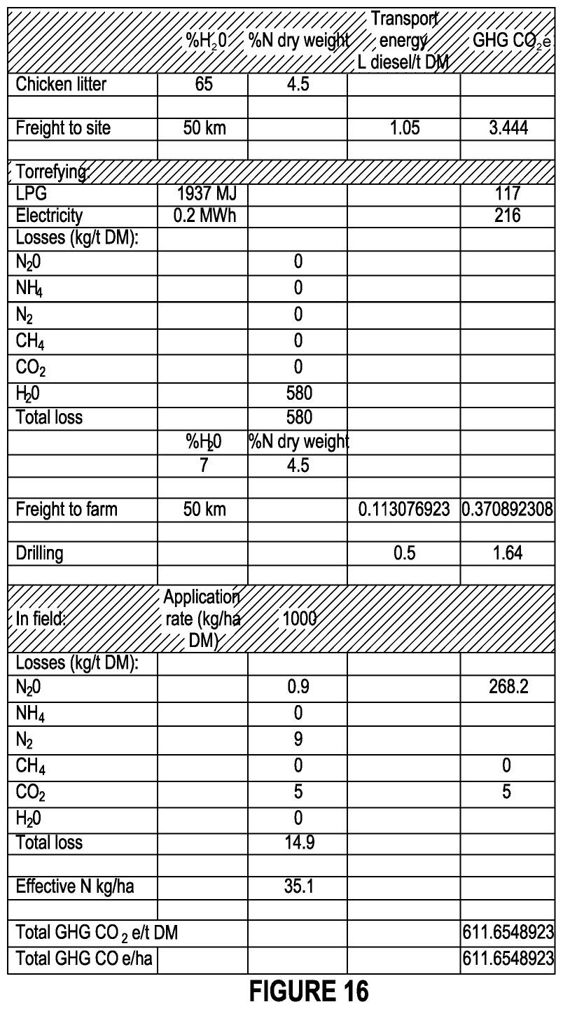

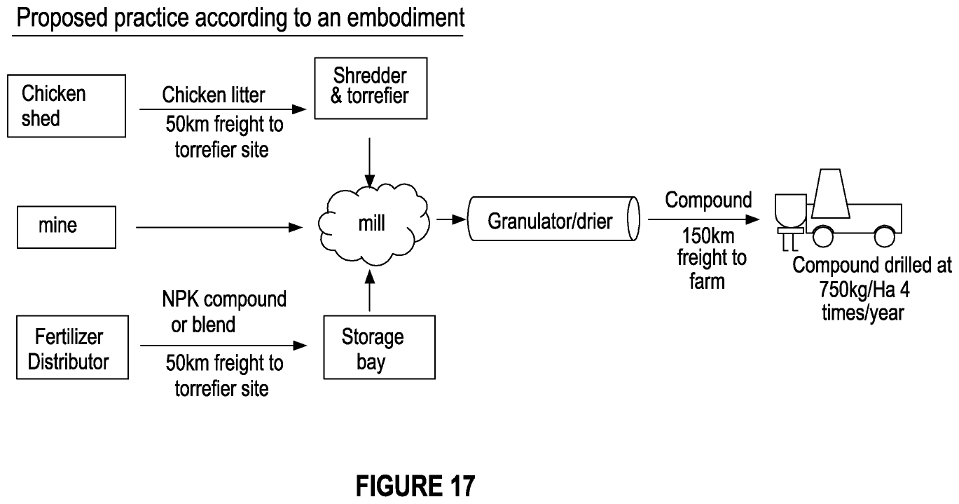

As can be seen from the Table of FIG. 16, for the purposes of assessing the GHG emissions for the LCA of the fertiliser, there is off-gassing of the chicken litter since it is torrefied. Rather than the chicken litter decomposing slowly over time during composting, the chicken litter is torrefied using a process similar to that outlined if FIG. 5. The gases produced during torrefaction are largely condensed. Accordingly, only the GHG emissions of the torrefier and the other process equipment are calculated. These are estimated as 333 kg GHG CO2e.

The transport load of the chicken litter compost to the torrefier is estimated at and about 50 km freight of torrefied material to farm (total 100 km). The amount of diesel is estimated at about 3.8 kg GHG CO2e. This is shown schematically in FIG. 16.

The drilling of the fertiliser in the field is estimated to generate about 1.64 kg GHG CO2e.

In the field, the GHG emitted is estimated to be 273 kg GHG CO2e.

In total, the GHG CO2e/ha is 611.65 kg. There is the equivalent of 1 tonne of organic based fertiliser applied in the year.

The assumptions that the horticultural grower is planting 4 crops per year, and that there is no application of compost.

The above example demonstrates the reduction in GHG emission for the present fertiliser. For the standard practice there is 2 t/ha dry matter as compost a year. For the fertiliser according to the invention (assuming product is about 33% organic material) there are 4 applications of 250 kg or a total of only 1 t/ha dry matter as organics per year. Thus, there is half the amount of organic material applied for the fertiliser according to the present invention when compared to the fertiliser of the standard practice.

### Example 8— Field Trials

The in-field emission calculations of Example 7 were validated in a field trial. At a celery farm, four treatments were applied:
Control (no fertiliser);
Inorganic NPK fertiliser+side dress N applications at various stages;
Aged chicken manure+Inorganic Fert; and
Torrefied organics (C1, see FIG. 13)+Inorganic ferts.

The two organic treatments were applied at an equivalent N rate/ha so that torrefied organics were applied at 64% of the rate of manure on a wet basis (factoring for water loss in the manure—roughly equivalent dry mass each organic type was applied). The aged manure was 3.24% N on a dry basis whereas the C1 is around 3.6% N, so on a dry basis, a bit less C1 was applied.

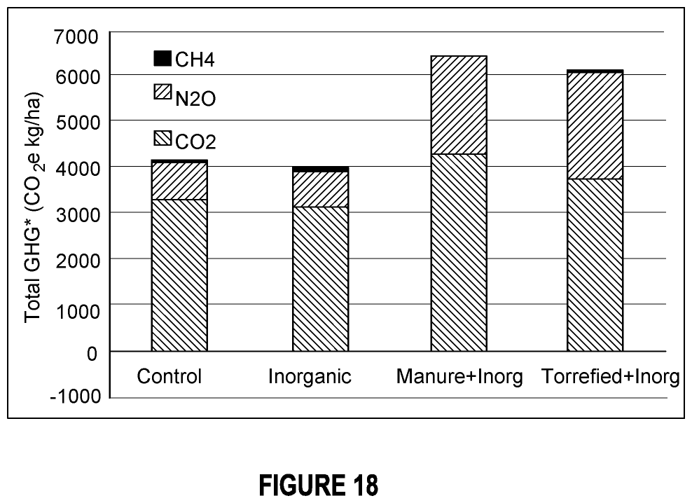

The results are shown in FIG. 18 and FIG. 26. The field portions treated with torrefied organics and inorganic fertilizer had less overall GHG emissions, than the aged chicken manure plus inorganic fertilizer. The data shows that at roughly equivalent tonnage, the GHG emissions for an embodiment of the present disclosure is less than that of a typical conventional organic fertilizer. The main point is that while on a like for like (N rate) basis, similar or slightly lower overall CO2-e emissions occurred, the production data shows that equivalent production outcomes can be achieved with substantially lower rates of C1 v's aged manure or compost.

It is noted that the slightly higher N2O emissions from the torrefied material versus manure suggests better nutrient availability to the plants at an early stage. It is expected that emissions would have been higher from fresh manure that had not been aged.

### Example 9—More Field Trials

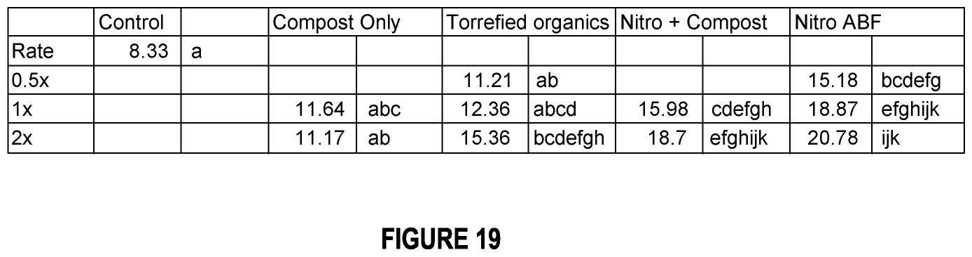

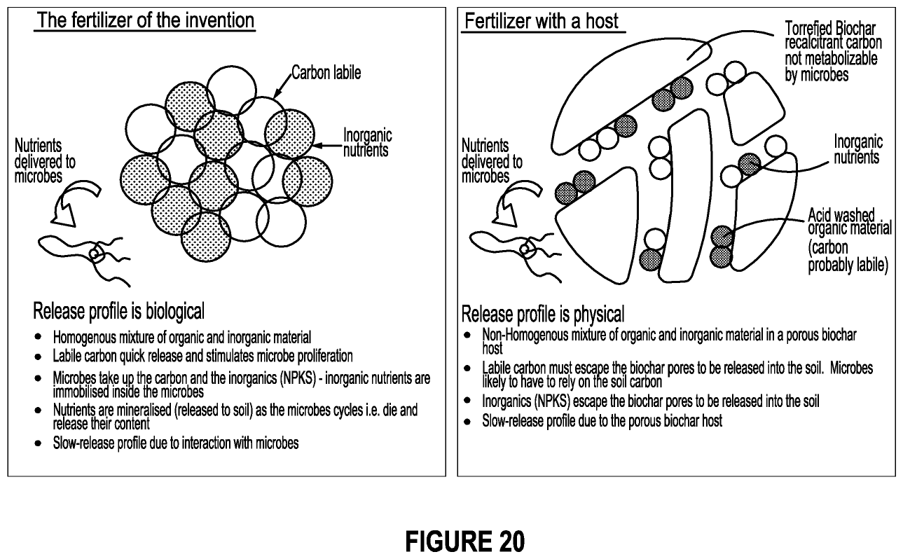

The life cycle analysis of Example 7 was based on the ability to reduce the tonnage of the inventive products by half as compared to conventional organic fertilizers. In order to demonstrate that lower rates of torrefied material (or torrefied base compounded with inorganics) can be used data from broccoli field trial yields was gathered. The results are shown in the Table of FIG. 19.

The table of FIG. 19 makes clear that there is no significant difference in yield when 0.5 rate of torrefied organics (C1) is compared to compost at double the rate (1×).

Similarly, if comparing 1× rate of torrefied organics with 2× rate of compost there is the same trend when comparing B7 (see FIG. 13) with higher rates of NPK compound+separate application of compost. If the same letter is alongside a treatment then this treatment was not significantly different at the 95% confidence level.

Conclusion—substantially lower rates of the fertiliser according to an embodiment of the present invention can be used to arrive at the same production outcome while generating substantially lower GHG emissions.

Aside from the trials demonstrating that this rate reduction is practical, it makes sense in that the granular material will be placed in the root zone whereas compost is generally distributed only partly in the root zone and as a result is more susceptible to losses.

### Example 10—Biological Release Profile

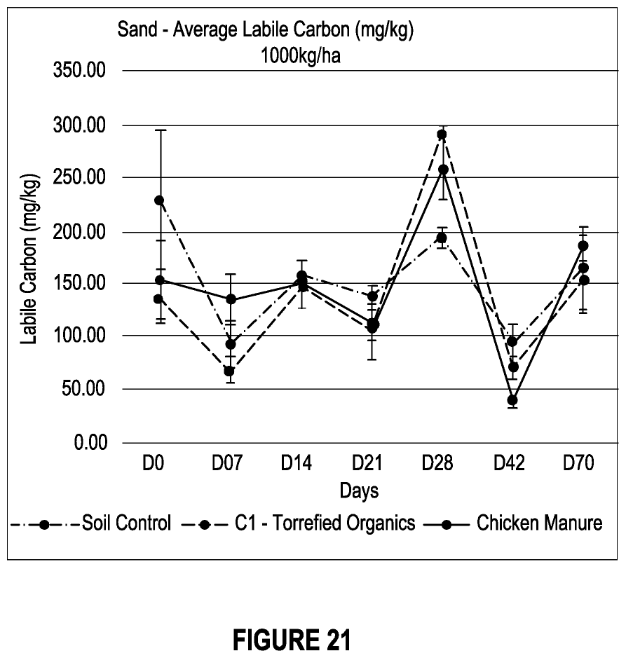

The biological release profile of a fertiliser according to an embodiment can be seen in the graph of FIG. 21. The graph shows that when torrefied organics (C1) are applied to soil, an increase in labile carbon of about 300 mg/kg after 28 days is observed. This is about equivalent to the lability of carbon in raw chicken manure. The increase in labile carbon is followed by a steep decline to day 42 which suggests that application of torrefied material/manure provides labile carbon which is then rapidly used as an energy source by microbes as they proliferate which leads to the decline back to control levels after 42 days.

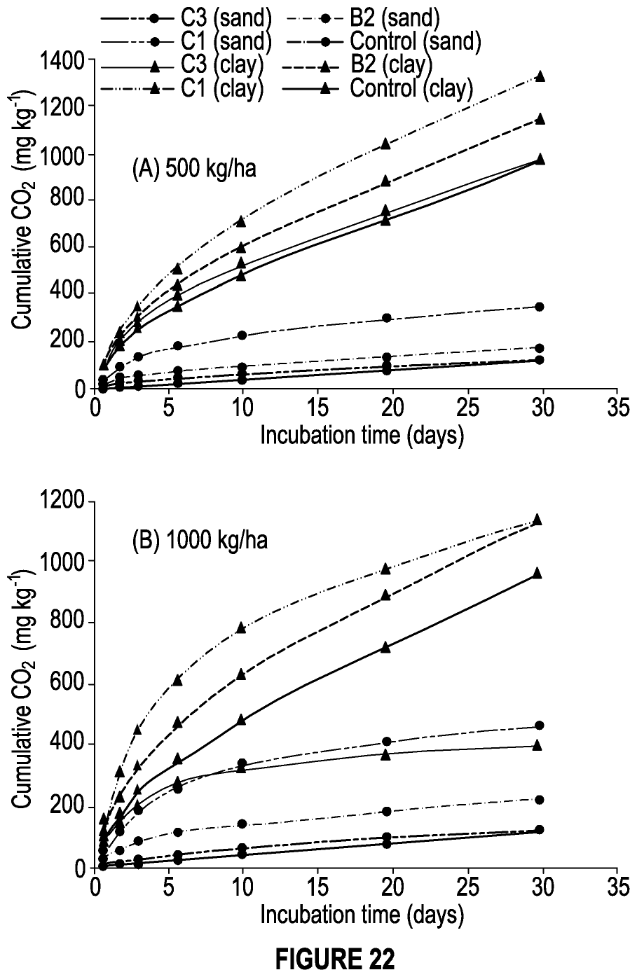

FIG. 22 shows response of cumulative CO₂ release to addition of different types of fertilizers at 500 (A) and 1000 (B) kg ha⁻¹ in sand and clay soils during 30-day incubation, noting that all soils had been pre-incubated for 14 days. Of note is the substantial increase in CO₂ release from the torrefied organics (C1) demonstrating the labile nature of the carbon. The analysis of products included are:

| Product | N | P | K | S | C | Ca |
|---|---|---|---|---|---|---|
| C1 | 4.0 | 1.8 | 1.6 | 1.0 | 38 | 5.1 |
| C3 | 14.6 | 12.0 | 11.0 | 5.2 | 0 | 0 |
| B2 | 14.4 | 0.7 | 0.6 | 15.2 | 15.3 | 1.9 |

Note that C3 is made up of entirely inorganic ingredients which explains why there is little if any difference compared with the control in terms of CO₂ release.

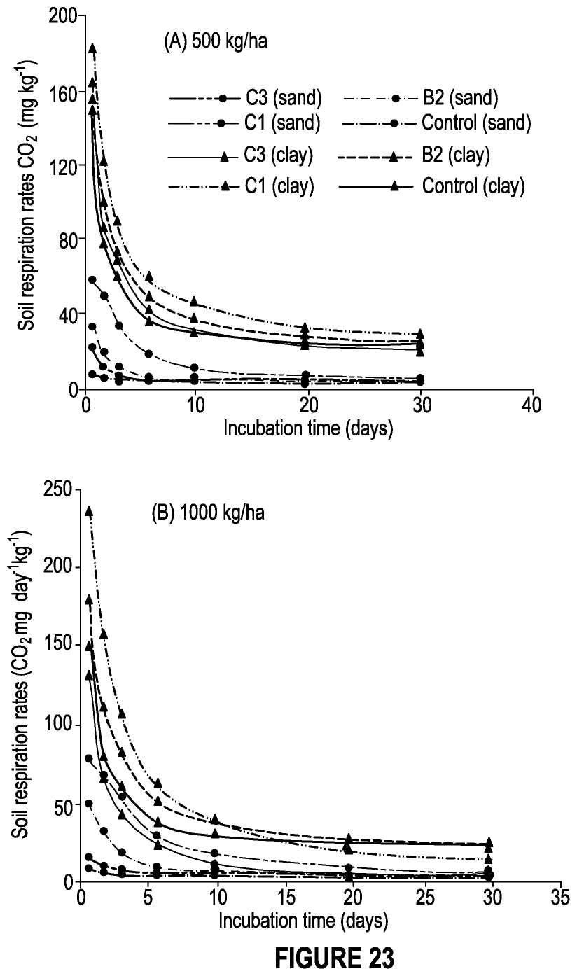

FIG. 23 shows response of soil daily CO₂ release rates to addition of different types of fertilizers at 500 (A) and 1000 (B) kg ha⁻¹ in sand and clay soil during 30-day incubation, noting that all soils had been pre-incubated for 14 days. Of note is the high initial CO₂ release from the torrefied organics (C1) demonstrating the labile nature of the carbon.

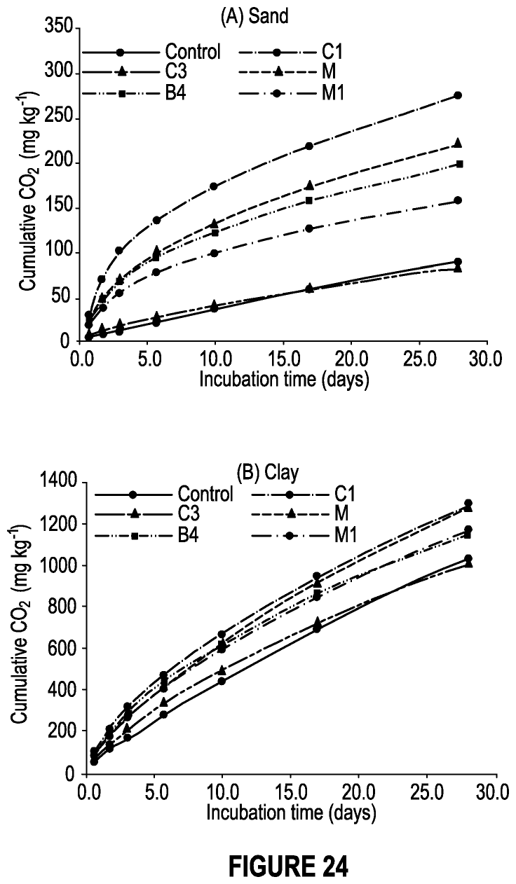

FIG. 24 shows response of soil cumulative CO₂ release rates to addition of different types of fertilizers at 500 (A) and 1000 (B) kg ha⁻¹ in sand and clay soil during 28-day incubation, noting that all soils had been pre-incubated for 14 days. In these experiments, we believe a manure and compost source (M & M1) was included for comparison (just confirming with researchers the source/analysis of these products). Of note is the substantial CO₂ release from the torrefied organics (C1) demonstrating the labile nature of the carbon. The extra CO₂ release from torrefied organics (C1) compared with manure sources may be attributed to the high surface areas of particles that make up this formulation relative to manure.

| Product | N | P | K | S | C | Ca |
|---|---|---|---|---|---|---|
| C1 | 4.0 | 1.8 | 1.6 | 1.0 | 38 | 5.1 |
| C3 | 14.6 | 12.0 | 11.0 | 5.2 | 0 | 0 |
| B4 | 9.6 | 4.7 | 10.6 | 5.9 | 15.3 | 1.9 |

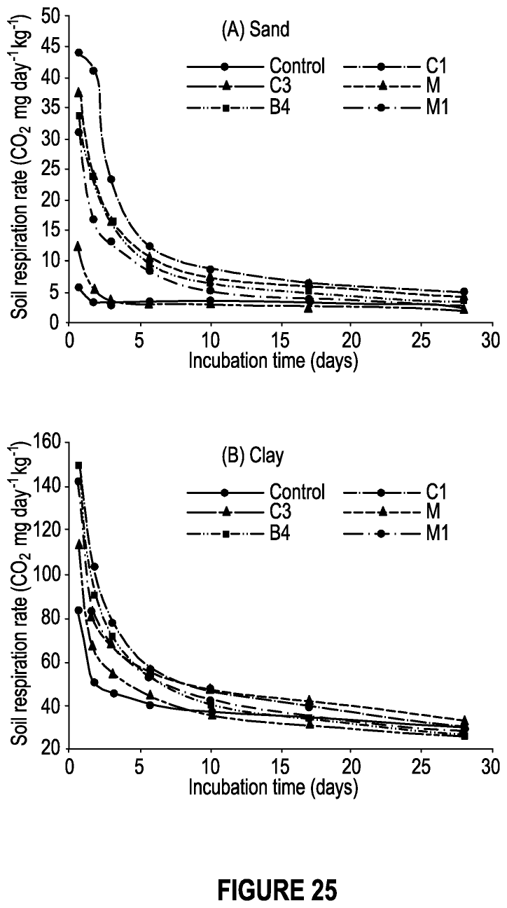

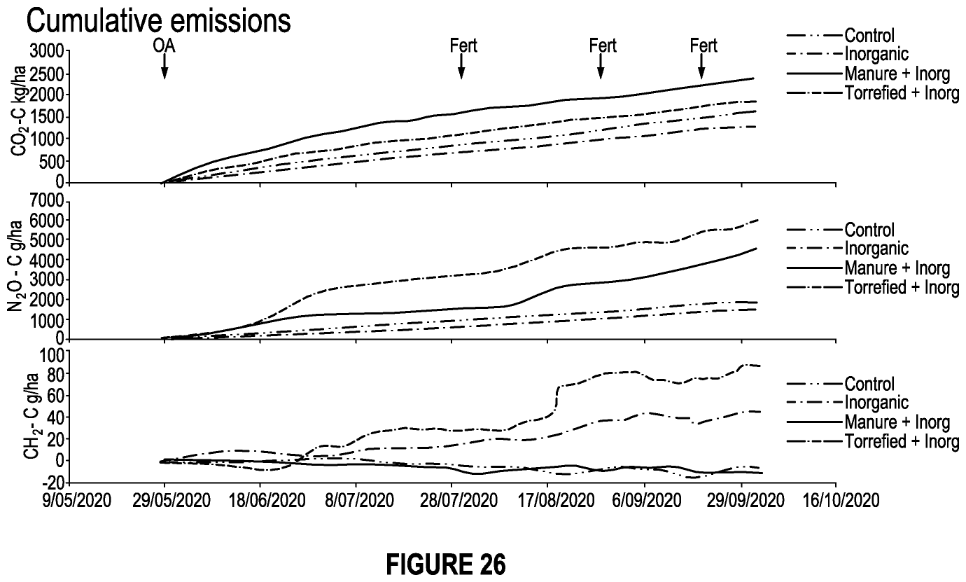

FIG. 25 shows response of soil daily CO₂ release rates to addition of different types of fertilizers at 500 (A) and 1000 (B) kg ha⁻¹ in sand and clay soil during 28-day incubation, noting that all soils had been pre-incubated for 14 days. In these experiment 2 manure sources (M & M1) (where M=manure; M1=manure+NPK fertilizer) were included for comparison. Of note is the substantial CO₂ release from the torrefied organics (C1) demonstrating the labile nature of the carbon. The extra CO₂ release from torrefied organics (C1) compared with manure sources may be attributed to the high surface areas of particles that make up this formulation relative to manure.

Any promises made in the present description should be understood to relate to some embodiments of the invention, and are not intended to be promises made about the invention. Where there are promises that are deemed to apply to all embodiments of the invention, the right is reserved to later delete those promises from the description since there is no intention to rely on those promises for the acceptance or subsequent grant of a patent unless the context makes clear otherwise.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will of course be realized that while the foregoing has been given by way of illustrative example of this invention, all such and other modifications and variations thereto as would be apparent to persons skilled in the art are deemed to fall within the broad scope and ambit of this invention as is herein set forth.

1. A solid compounded fertilizer in the form of discrete particles, the solid fertiliser having a biological release profile, the solid fertilizer comprising, in a single particle:
(i) a torrefied organic waste comprising labile carbon;
(ii) a binder;
wherein the torrefied organic material is bound by the binder into the single particle thereby the labile carbon of the organic material is readily available for metabolism by microbes following application of the compounded fertilizer composition to soil or growing media.

2. The solid fertiliser of claim 1, further comprising
(iii) an inorganic or synthetic material.

3. The solid fertiliser of claim 2, wherein the torrefied organic material and the inorganic or synthetic material are bound together into the single particle by the binder, thereby the labile carbon of the organic material and the inorganic or synthetic material are each readily available for metabolism by microbes following application of the fertilizer.

4. The solid fertiliser of claim 2, wherein the inorganic or synthetic material is a coating around at least some of the outside surface of the torrefied organic material bound by the binder.

5. The solid fertiliser according to any one of claims 1 to 4, wherein the binder is leonardite.

6. The solid fertiliser according to any one of claims 1 to 5 comprising at least about 5 w/w % of binder

7. The solid fertiliser according to any one of claims 1 to 6, wherein the moisture content of the single particle is less then 8 wt %.

8. The solid fertiliser according to any one of claims 1 to 7, wherein the crush strength is at least about 2.0 KgF

9. The solid fertiliser according to any one of claims 1 to 7 wherein the inorganic material comprises at least one of N, P, K or S nutrients.

10. The solid fertiliser according to any one of claims 1 to 7, wherein the synthetic material is selected from one or more of urea, monoammonium phosphate (MAP), diammonium phosphate (DAP), Sulphate of Ammonia (SOA), Muriate of Potash (MOP), Potassium sulphate (SOP), magnesium carbonate and plant available silicon.

11. The solid fertiliser according to any one of claims 1 to 10, wherein the discrete particles are granules or pellets.

12. The solid fertiliser according to claim 11, wherein the discrete particles are substantially spherical in shape and have an average particle size of about 2 to 5 mm in diameter.

13. The solid fertiliser according to any one of claims 1 to 12, wherein the discrete particles are coated with a hydrophobic coating,

14. The solid fertiliser according to any one of claims 1 to 13, further comprising a nitrification inhibitor selected from DMP and zinc.

15. The solid fertiliser according to any one of claims 1 to 14, further comprising an abiotic stress controller such as plant available silicon.

16. The solid fertiliser according to any one of claims 1 to 15, further comprising a probiotic or prebiotic coating to inoculate the soil with microbes.

17. A method of preparing a compounded fertilizer composition having a biological release profile upon application to soil, the method comprising the steps of:
torrefying an organic waste to provide a torrefied organic material comprising labile carbon,
milling the torrefied organic waste to produce a milled product, and
pelletising or granulating the milled product to form solid particles;
wherein the solid particles are held together by a binder.

18. The method of claim 18, wherein the binder is added during the pelletising or granulating of the milled product.

19. A method of reducing greenhouse gas emissions while substantially maintaining crop yield, the method comprising:
applying or having applied a fertilizer according to any one of claims 1 to 16 to the field in a single pass using broadcasting or drilling equipment, wherein the equipment is designed for the controlled dosing of particulate material.

20. A process for reducing the amount of GHG emissions measured from a lifecycle assessment of a fertiliser, the process comprising:
preparing or having prepared a solid fertiliser in accordance with any one of claims 1 to 16,
wherein during the step of or having prepared the solid fertiliser steps are taken to recover energy from the process,
applying the solid fertiliser to soil wherein the fertiliser are applied in a single-pass using equipment designed for the controlled dosing and placement of particulate material.
